(19) United States
(12) Patent Application Publication
(10) Pub. No.: US 2012/0002299 A1
(43) Pub. Date: Jan. 5, 2012

(54) HIGH ZOOM-RATIO ZOOM LENS SYSTEM

(75) Inventor: Koji KATO, Saitama (JP)

(73) Assignee: HOYA CORPORATION, Tokyo (JP)

(21) Appl. No.: 13/170,619

(22) Filed: Jun. 28, 2011

(30) Foreign Application Priority Data
Jul. 1, 2010 (JP) 2010-151284

(51) Int. Cl. G02B 15/14

(52) U.S. Cl. 359/687

(57) ABSTRACT

A high-ratio zoom lens system includes a positive first lens group, a negative second lens group, a positive third lens group, and a positive fourth lens group. Upon zooming from the short to long focal length extremities, the lens groups move while increasing the distance between the first and second lens groups, and decreasing the distance between the second and third lens groups. The first lens group includes a negative lens element having a concave surface on the image side, a positive lens element having a convex surface on the object side, and a positive lens element having a convex surface on the object side, in that order from the object side. The following conditions (1) and (2) are satisfied:

1.7<f1/f4<2.02 (1), and

1.82<(f1×f4)/(f3)²<2.3 (2),

wherein f1, f3 and f4 designate the focal length of the first, third and fourth lens groups, respectively.

### BACKGROUND OF THE INVENTION

1. Field of the Invention

The present invention relates to a high zoom-ratio zoom lens system that is suitable for an imaging optical system of a digital camera that is provided with a small (compact) image sensor.

2. Description of Related Art

In recent years, technical advancement in providing higher zoom ratios have occurred in zoom lens systems, while the demand for further miniaturization in zoom lens systems due to further miniaturization of the camera body has also increased. For example, zoom lens systems having five lens groups, i.e., a positive lens group, a negative lens group, a positive lens group, a negative lens group and a positive lens group (Japanese Unexamined Patent Publication Nos. 2009-244443 and 2009-175324), and zoom lens systems having four lens groups, i.e., a positive lens group, a negative lens group, a positive lens group and a positive lens group (Japanese Unexamined Patent Publication Nos. 2009-58980 and 2005-331697), are known in the art as relatively high zoom-ratio zoom lens systems.

However, in zoom lens systems having five lens groups (i.e., a positive lens group, a negative lens group, a positive lens group, a negative lens group and a positive lens group) as disclosed in the above-mentioned Japanese Unexamined Patent Publication Nos. 2009-244443 and 2009-175324, due to such zoom lens systems having five lens groups, a problem occurs with the size of the zoom lens system becoming larger due to an increased number of components and further complexity of the mechanical structures therefor, which makes it very difficult to achieve a compact zoom lens system.

Furthermore, in zoom lens systems having four lens groups (i.e., a positive lens group, a negative lens group, a positive lens group and a positive lens group), disclosed in the above-mentioned Japanese Unexamined Patent Publication No. 2009-58980, the overall length of the zoom lens system at the short focal length extremity is great; and, the zoom lens system is not sufficiently miniaturized. Furthermore, in the zoom lens system disclosed in the above-mentioned Japanese Unexamined Patent Publication No. 2005-331697, although miniaturization is achieved, the focal length at the long focal length extremity is 120 mm and the zoom ratio is 6.4:1, which is somewhat small.

Furthermore, there is also the demand for favorable correction of lateral chromatic aberration in a high zoom-ratio zoom lens system regardless of whether a four-lens-group or a five-lens-group design is utilized.

### SUMMARY OF THE INVENTION

The present invention provides a compact, high-quality high zoom-ratio zoom lens system that achieves an angle-of-view of approximately 76 degrees at the short focal length extremity, a zoom ratio of approximately 7.0:1, has a back focal distance that is long enough for use in an SLR camera having an interchangeable lens, and which can favorably correct lateral chromatic aberration.

According to an aspect of the present invention, there is provided a high-ratio zoom lens system including a positive first lens group (hereinafter, a first lens group), a negative second lens group (hereinafter, a second lens group), a positive third lens group (hereinafter, a third lens group), and a positive fourth lens group, in that order from the object.

Upon zooming from the short focal length extremity to the long focal length extremity, the first through fourth lens groups move along the optical axis thereof while the distance between the first and second lens groups increases, and the distance between the second and third lens groups decreases.

The first lens group includes a negative lens element having a concave surface on the image side, a positive lens element having a convex surface on the object side, and a positive lens element having a convex surface on the object side, in that order from the object.

The high-ratio zoom lens system satisfies the following conditions:

1.7<f1/f4<2.02 (1)

1.82<(f1×f4)/(f3)²<2.3 (2)

wherein f1 designates the focal length of the first lens group; f3 designates the focal length of the third lens group; and f4 designates the focal length of the fourth lens group.

The high-ratio zoom lens system preferably satisfies the following condition:

|ΔP₁₁₋₁₂/Δνd₁₁₋₁₂|<0.0015 (3)

wherein

ΔP₁₁₋₁₂=(ΔP_{g-F}11−ΔP_{g-F}12), and

Δνd₁₁₋₁₂=νd11−νd12,

wherein ΔP_{g-F}11 designates the partial dispersion ratio of the negative lens element which is provided in the first lens group; ΔP_{g-F}12 designates the partial dispersion ratio of the object-side positive lens element in the first lens group; νd11 designates the Abbe number with respect to the d-line of the negative lens element which is provided in the first lens group; and νd12 designates the Abbe number with respect to the d-line of the object-side positive lens element in the first lens group.

Within the range of condition (3), the high-ratio zoom lens system more preferably satisfies the following condition:

|ΔP₁₁₋₁₂/Δνd₁₁₋₁₂|<0.0013 (3′)

It is desirable for the fourth lens group to include a positive lens element, and a cemented lens formed from a negative lens element and a positive lens element, in that order from the object.

The high-ratio zoom lens system preferably satisfies the following condition:

νd41>80 (4)

wherein νd41 designates the Abbe number with respect to the d-line of the object-side positive lens element in the fourth lens group.

Within the range of condition (4), the high-ratio zoom lens system more preferably satisfies the following condition:

νd41>90 (4′)

It is desirable for the third lens group to include a positive lens element, a positive lens element, and a negative lens element having a concave surface on the object side, in that order from the object.

According to the present invention, a compact, high-quality high zoom-ratio zoom lens system can be achieved which has an angle-of-view of approximately 76 degrees at the short focal length extremity, a zoom ratio of approximately 7.0:1, has a back focal distance that is long enough for use in an SLR camera having an interchangeable lens, and which can favorably correct lateral chromatic aberration.

The present disclosure relates to subject matter contained in Japanese Patent Application No. 2010-151284 (filed on Jul. 1, 2010) which is expressly incorporated herein in its entirety.

### BRIEF DESCRIPTION OF THE DRAWINGS

The present invention will be discussed below in detail with reference to the accompanying drawings, in which:

FIG. 1 shows a lens arrangement of a first numerical embodiment of a high zoom-ratio zoom lens system, according to the present invention, when an object at infinity is in an in-focus state at the long focal length extremity;

FIGS. 2A, 2B, 2C and 2D show various aberrations that occurred in the lens arrangement shown in FIG. 1;

FIGS. 3A, 3B, 3C and 3D show various lateral aberrations that occurred in the lens arrangement shown in FIG. 1;

FIG. 4 shows a lens arrangement of the first numerical embodiment of the high zoom-ratio zoom lens system, according to the present invention, when an object at infinity is in an in-focus state at the short focal length extremity;

FIGS. 5A, 5B, 5C and 5D show various aberrations that occurred in the lens arrangement shown in FIG. 4;

FIGS. 6A, 6B, 6C and 6D show various lateral aberrations that occurred in the lens arrangement shown in FIG. 4;

FIG. 7 shows a lens arrangement of a second numerical embodiment of the high zoom-ratio zoom lens system, according to the present invention, when an object at infinity is in an in-focus state at the long focal length extremity;

FIGS. 8A, 8B, 8C and 8D show various aberrations that occurred in the lens arrangement shown in FIG. 7;

FIGS. 9A, 9B, 9C and 9D show various lateral aberrations that occurred in the lens arrangement shown in FIG. 7;

FIG. 10 shows a lens arrangement of the second numerical embodiment of the high zoom-ratio zoom lens system, according to the present invention, when an object at infinity is in an in-focus state at the short focal length extremity;

FIGS. 11A, 11B, 11C and 11D show various aberrations that occurred in the lens arrangement shown in FIG. 10;

FIGS. 12A, 12B, 12C and 12D show various lateral aberrations that occurred in the lens arrangement shown in FIG. 10;

FIG. 13 shows a lens arrangement of a third numerical embodiment of the high zoom-ratio zoom lens system, according to the present invention, when an object at infinity is in an in-focus state at the long focal length extremity;

FIGS. 14A, 14B, 14C and 14D show various aberrations that occurred in the lens arrangement shown in FIG. 13;

FIGS. 15A, 15B, 15C and 15D show various lateral aberrations that occurred in the lens arrangement shown in FIG. 13;

FIG. 16 shows a lens arrangement of the third numerical embodiment of the high zoom-ratio zoom lens system, according to the present invention, when an object at infinity is in an in-focus state at the short focal length extremity;

FIGS. 17A, 17B, 17C and 17D show various aberrations that occurred in the lens arrangement shown in FIG. 16;

FIGS. 18A, 18B, 18C and 18D show various lateral aberrations that occurred in the lens arrangement shown in FIG. 16;

FIG. 19 shows a lens arrangement of a fourth numerical embodiment of the high zoom-ratio zoom lens system, according to the present invention, when an object at infinity is in an in-focus state at the long focal length extremity;

FIGS. 20A, 20B, 20C and 20D show various aberrations that occurred in the lens arrangement shown in FIG. 19;

FIGS. 21A, 21B, 21C and 21D show various lateral aberrations that occurred in the lens arrangement shown in FIG. 19;

FIG. 22 shows a lens arrangement of the fourth numerical embodiment of the high zoom-ratio zoom lens system, according to the present invention, when an object at infinity is in an in-focus state at the short focal length extremity;

FIGS. 23A, 23B, 23C and 23D show various aberrations that occurred in the lens arrangement shown in FIG. 22;

FIGS. 24A, 24B, 24C and 24D show various lateral aberrations that occurred in the lens arrangement shown in FIG. 22;

FIG. 25 shows a lens arrangement of a fifth numerical embodiment of the high zoom-ratio zoom lens system, according to the present invention, when an object at infinity is in an in-focus state at the long focal length extremity;

FIGS. 26A, 26B, 26C and 26D show various aberrations that occurred in the lens arrangement shown in FIG. 25;

FIGS. 27A, 27B, 27C and 27D show various lateral aberrations that occurred in the lens arrangement shown in FIG. 25;

FIG. 28 shows a lens arrangement of the fifth numerical embodiment of the high zoom-ratio zoom lens system, according to the present invention, when an object at infinity is in an in-focus state at the short focal length extremity;

FIGS. 29A, 29B, 29C and 29D show various aberrations that occurred in the lens arrangement shown in FIG. 28;

FIGS. 30A, 30B, 30C and 30D show various lateral aberrations that occurred in the lens arrangement shown in FIG. 28;

FIG. 31 shows a lens arrangement of a sixth numerical embodiment of the high zoom-ratio zoom lens system, according to the present invention, when an object at infinity is in an in-focus state at the long focal length extremity;

FIGS. 32A, 32B, 32C and 32D show various aberrations that occurred in the lens arrangement shown in FIG. 31;

FIGS. 33A, 33B, 33C and 33D show various lateral aberrations that occurred in the lens arrangement shown in FIG. 31;

FIG. 34 shows a lens arrangement of the sixth numerical embodiment of the high zoom-ratio zoom lens system, according to the present invention, when an object at infinity is in an in-focus state at the short focal length extremity;

FIGS. 35A, 35B, 35C and 35D show various aberrations that occurred in the lens arrangement shown in FIG. 34;

FIGS. 36A, 36B, 36C and 36D show various lateral aberrations that occurred in the lens arrangement shown in FIG. 34;

FIG. 37 shows a lens arrangement of a seventh numerical embodiment of the high zoom-ratio zoom lens system, according to the present invention, when an object at infinity is in an in-focus state at the long focal length extremity;

FIGS. 38A, 38B, 38C and 38D show various aberrations that occurred in the lens arrangement shown in FIG. 37;

FIGS. 39A, 39B, 39C and 39D show various lateral aberrations that occurred in the lens arrangement shown in FIG. 37;

FIG. 40 shows a lens arrangement of the seventh numerical embodiment of the high zoom-ratio zoom lens system, according to the present invention, when an object at infinity is in an in-focus state at the short focal length extremity;

FIGS. 41A, 41B, 41C and 41D show various aberrations that occurred in the lens arrangement shown in FIG. 40;

FIGS. 42A, 42B, 42C and 42D show various lateral aberrations that occurred in the lens arrangement shown in FIG. 40; and

FIGS. 43 shows lens-group moving paths of the high zoom-ratio zoom lens system according to the present invention.

### DESCRIPTION OF THE EMBODIMENTS

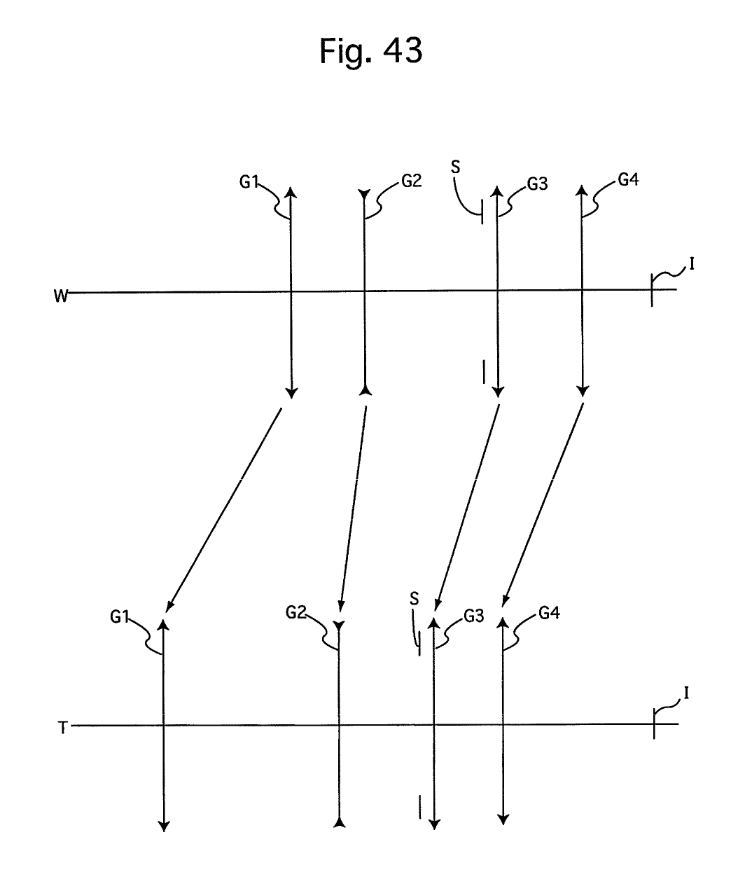

The high zoom-ratio zoom lens system according to the present invention, as shown in the lens-group moving paths of FIG. 43, is configured of a positive first lens group G1, a negative second lens group G2, a positive third lens group G3 and a positive fourth lens group G4, in that order from the object. A diaphragm S is provided between the second lens group G2 and the third lens group G3 and moves together with the third lens group G3 during zooming. ‘I’ designates an imaging plane. The second lens group G2 constitutes a focusing lens group which is moved (along the optical axis direction) during a focusing operation (i.e., performing a focusing operation on an object at a closer distance from infinity by advancing the second lens group).

Upon zooming from the short focal length extremity (W) to the long focal length extremity (T), the distance between the first lens group G1 and the second lens group G2 increases, the distance between the second lens group G2 and the third lens group G3 decreases, and each of the first through fourth lens groups G1 through G4 move monotonically toward the object. Note that the distance between the third lens group G3 and the fourth lens group G4 can either increase or decrease during zooming. Furthermore, the traveling distance (toward to the object) of the first lens group G1 is not only longer than that of the second lens group G2, but also longer than those of the third lens group G3and the fourth lens group G4.

In each of the first through seventh numerical embodiments, the first lens group G1 is configured of a cemented lens C1 which includes a negative meniscus lens element having the convex surface facing toward the object (and the concave surface facing toward the image), and a biconvex positive lens element 12, and a positive meniscus lens element 13 having the convex surface facing toward the object, in that order from the object. The negative meniscus lens element 11 and the biconvex positive lens element 12 do not necessarily need to be bonded to each other (to form a cemented lens).

In each of the first through seventh numerical embodiments, the second lens group G2 is configured of a negative meniscus lens element 21 having the convex surface facing toward the object, a biconcave negative lens element 22, a biconvex positive lens element 23, and a negative meniscus lens element 24 having the convex surface facing toward the image, in that order from the object. A compound resin aspherical layer is formed and bonded onto the surface on the object side of the negative meniscus lens element 21.

The third lens group G3 is configured of a biconvex positive lens element 31, a positive lens element 32 and a biconcave negative lens element 33, in that order from the object. The positive lens element 32 is a biconvex positive lens element in numerical embodiments 1, 3, 4, 6 and 7, and is a positive meniscus lens element having the convex surface facing toward the object in numerical embodiments 2 and 5.

In each of the first through seventh numerical embodiments, the fourth lens group G4 is configured of a biconvex positive lens element 41, and a cemented lens C4 formed from a biconcave negative lens element 42 and a biconvex positive lens element 43, in that order from the object. The biconvex positive lens element 43 is provided with an aspherical surface on the image side thereof.

The illustrated embodiments of the present invention employ an internal focusing lens system, in which the second lens group G2 is moved toward the object to carry out a focusing operation on an object at a closer distance from infinity. Due to the second lens group G2 being a focusing lens group, it is unnecessary to move a large lens group like the first lens group G1 in order to carry out an autofocusing operation. Consequently, the burden on the driving system when autofocusing is performed is reduced, so that a rapid focusing operation can be attained. Furthermore, little loss in peripheral illumination occurs during close-up photography, and the diameter of the first lens group G1 (frontmost lens group) can be maintained relatively smaller; hence, such an internal focusing lens system has many practical advantages, including being advantageous for achieving further miniaturization (compactness), etc.

Condition (1) specifies the ratio of the focal length of the first lens group G1 to the focal length of the fourth lens group G4 in order to favourably correct lateral chromatic aberration and achieve further miniaturization of the zoom lens system while maintaining superior optical quality.

If the upper limit of condition (1) is exceeded, the refractive power of the first lens group G1 becomes weak, and hence, the travelling distance of the first lens group G1 during zooming from the short focal length extremity to the long focal length extremity increases, so that miniaturization of the zoom lens system becomes difficult. Furthermore, due to the increased movement amount of the first lens group G1, the symmetry of the first and fourth lens groups G1 and G4 with respect to the diaphragm S is lost, making it difficult to correct lateral chromatic aberration.

If the lower limit of condition (1) is exceeded, since the refractive power of the first lens group G1 becomes strong, although this is advantageous for miniaturization of the zoom lens system, it becomes difficult to correct spherical aberration and coma at the long focal length extremity.

Condition (2) specifies, using the three positive lens groups (first lens group G1, third lens group G3 and fourth lens group G4), the refractive power balance between the refractive powers of the first and fourth lens groups G1 and G4 (which are positioned on the object and image sides, respectively) and the refractive power of the third lens group G3.

If the upper limit of condition (2) is exceeded, since the refractive power of the third lens group G3 becomes weak, the traveling distance of the third lens group G3 during zooming increases, thereby increasing the overall size (length) of the entire zoom lens system. If the positive refractive power of the fourth lens group G4 is strengthened (increased) in order to avoid an increase in size of the zoom lens system, it becomes difficult to correct off-axis coma.

If the lower limit of condition (2) is exceeded, since the refractive power of the third lens group G3 becomes strong, it becomes difficult to correct spherical aberration that occurs at the long focal length extremity. Nevertheless, if the refractive power of the second lens group G2 is strengthened in order to correct the spherical aberration, a large amount of distortion occurs.

In each of the first through seventh numerical embodiments, a glass material having a particular dispersion ability is used in the first lens group G1 and the fourth lens group G4 to favourably correct lateral chromatic aberration. The Abbe number (dispersion) νd with respect to the d-line is defined as νd=(nd−1)/(nF−nC) and the partial dispersion ratio ΔP_{g-F} is defined as ΔP_{g-F}=(ng−nF)/(nF−nC), wherein ng designates a wavelength of 436 nm (g-line), nF designates a wavelength of 486 nm (F-line), nd designates a wavelength of 588 nm (d-line) and nC designates a wavelength of 656 nm (C-line).

Condition (3) specifies the combination of glass materials of the negative lens element (11) and the object-side positive lens element (12) in the first lens group G1 by the parameters of the partial dispersion ratio ΔP_{g-F} and those of the Abbe number νd in order to reduce the secondary spectrum. It becomes possible to favourably correct lateral chromatic aberration by satisfying condition (3). Furthermore, by satisfying condition (3)′, the lateral chromatic aberration can be more favourably corrected.

If the upper limit of condition (3) is exceeded, the secondary spectrum becomes large, and lateral chromatic aberration undesirably occurs, especially at the long focal length extremity.

As shown in each of the first through seventh embodiments, the fourth lens group G4 is configured of a positive lens element, and a cemented lens formed from a negative lens element and a positive lens element, in that order from the object, so as to constitute a three-lens-element arrangement.

In the case where the fourth lens group G4 has the above-described arrangement, condition (4) specifies the Abbe number with respect to the d-line of the positive lens element that is provided at the object side within the fourth lens group G4. It is possible to favorably correct lateral chromatic aberration by satisfying condition (4). Furthermore, by satisfying condition (4)′, the lateral chromatic aberration can be more favourably corrected.

If the lower limit of condition (4) is exceeded, the secondary spectrum becomes large, and lateral chromatic aberration undesirably occurs, especially at the long focal length extremity.

### Embodiments

Specific numerical embodiments will be herein discussed. The following numerical embodiments are applied to a zoom lens system used in a digital SLR camera.

In the diagrams of chromatic aberration (axial chromatic aberration) represented by spherical aberration, the solid line and the four types of dotted lines respectively indicate spherical aberrations with respect to the d, g, C, F and e lines.

In the diagrams of lateral chromatic aberration, Y designates the image height, the four types of dotted lines respectively indicate magnification with respect to the g, C, F and e lines; however, the d line as the base line coincides with the ordinate.

In the diagrams of astigmatism, y designates the image height, S designates the sagittal image, and M designates the meridional image.

In the diagrams of distortion, Y designates the image height.

In the diagrams of lateral aberrations, the solid line and the dotted line respectively indicate spherical aberrations with respect to the d, g, C, F and e lines.

Fno. designates the f-number, f designates the focal length of the entire optical system, W designates the half angle of view (°), Y designates the image height, fB designates the back focal distance, L designates the overall length of the lens system, r designates the radius of curvature, d designates the lens thickness or distance between lenses, Nd designates the refractive index with respect to the d-line, and νd designates the Abbe number with respect to the d-line. With respect to an aspherical coefficient, “E-a” designates “×10^{-a}”. The values for the f-number, the focal length, the half angle-of-view, the image height, the back focal distance, the overall length of the lens system, and the distance between lenses (which changes during zooming and according to the overall length of the lens system) are shown in the following order: short focal length extremity, intermediate focal length, and long focal length extremity.

An aspherical surface which is rotationally symmetrical about the optical axis is defined as:

x=cy²/(1+[1−{1+K}c²y²]^{1/2})+A4y⁴+A6y⁶+A8y⁸+A10y¹⁰+A12y¹² . . .

wherein

‘x’ designates a distance from a tangent plane of the aspherical vertex, ‘c’ designates the curvature (1/r) of the aspherical vertex, ‘y’ designates the distance from the optical axis, ‘K’ designates the conic coefficient, A4 designates a fourth-order aspherical coefficient, A6 designates a sixth-order aspherical coefficient, A8 designates an eighth-order aspherical coefficient, A10 designates a tenth-order aspherical coefficient, and A12 designates a twelfth-order aspherical coefficient.

### Embodiment 1

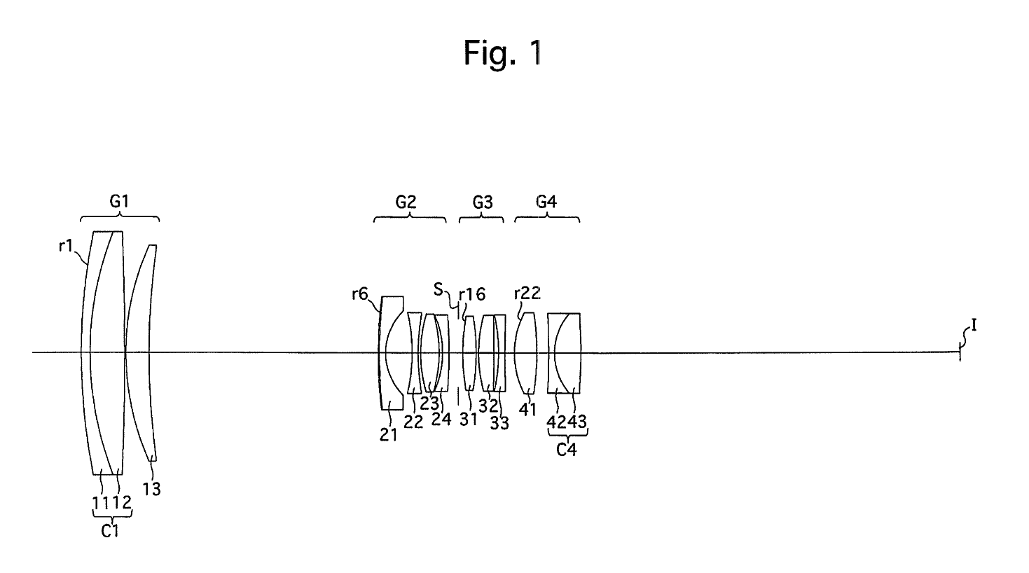

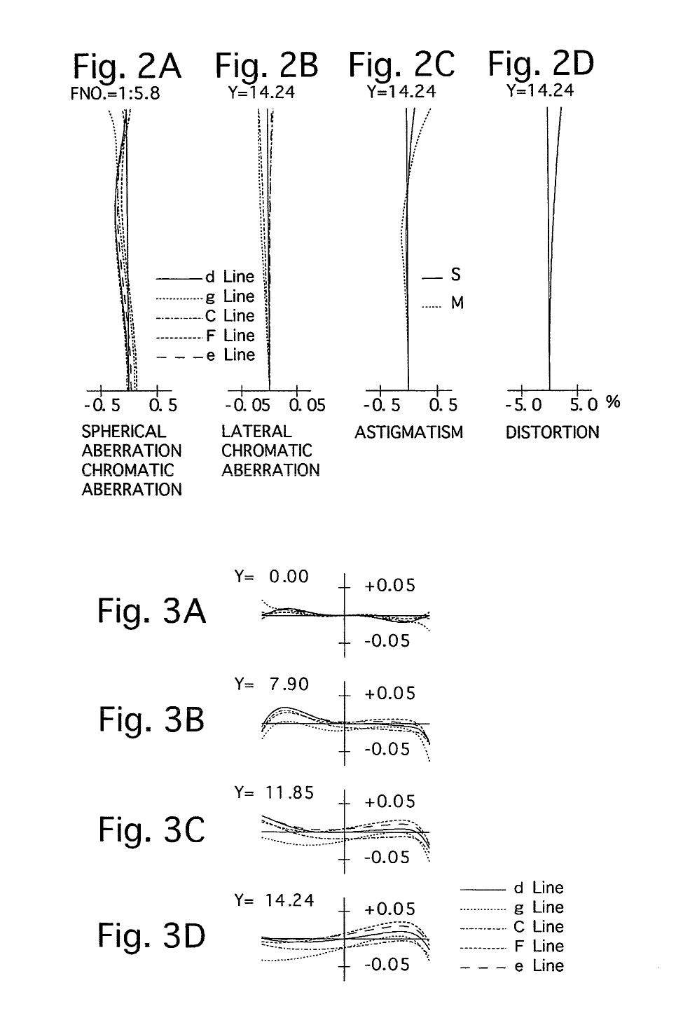

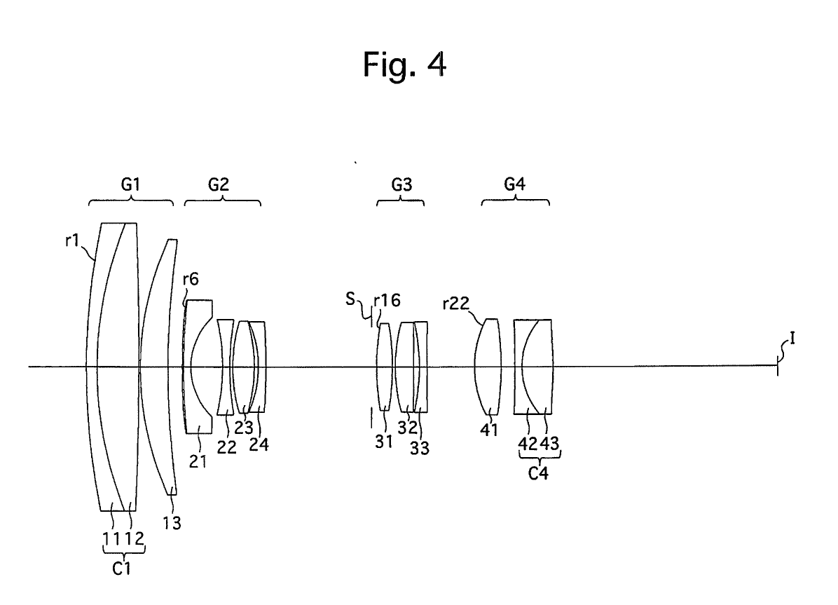

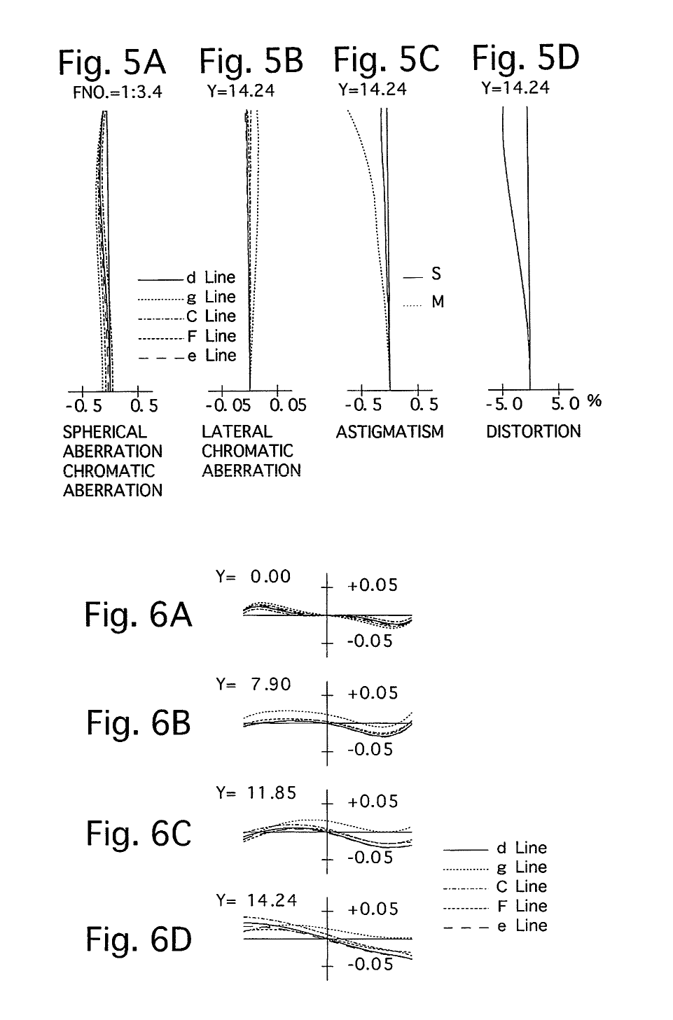

FIGS. 1 through 6D and Tables 1 through 4 show a first numerical embodiment of a high zoom-ratio zoom lens system according to the present invention. FIG. 1 shows a lens arrangement of the first numerical embodiment of the high zoom-ratio zoom lens system when an object at infinity is in an in-focus state at the long focal length extremity. FIGS. 2A, 2B, 2C and 2D show various aberrations that occurred in the lens arrangement shown in FIG. 1. FIGS. 3A, 3B, 3C and 3D show various lateral aberrations that occurred in the lens arrangement shown in FIG. 1. FIG. 4 shows a lens arrangement of the first numerical embodiment of the high zoom-ratio zoom lens system, according to the present invention, when an object at infinity is in an in-focus state at the short focal length extremity. FIGS. 5A, 5B, 5C and 5D show various aberrations that occurred in the lens arrangement shown in FIG. 4. FIGS. 6A, 6B, 6C and 6D show various lateral aberrations that occurred in the lens arrangement shown in FIG. 4. Table 1 shows the lens surface data, Table 2 shows various zoom lens system data, Table 3 shows the aspherical surface data, and Table 4 shows the lens group data of the zoom lens system according to first numerical embodiment.

The high zoom-ratio zoom lens system of the first numerical embodiment is configured of a positive first lens group G1, a negative second lens group G2, a positive third lens group G3, and a positive fourth lens group G4, in that order from the object. The second lens group G2 constitutes a focusing lens group that is moved along the optical axis direction for causing a focusing operation. More specifically, focusing is performed on an object at a closer distance from infinity by advancing the second lens group toward the object.

The first lens group G1 (surface Nos. 1 through 5) is configured of a cemented lens C1 formed from a negative meniscus lens element 11 having the convex surface facing toward the object (and the concave surface facing toward the image) and a positive biconvex lens element 12, and a positive meniscus lens element 13 having the convex surface facing toward the object, in that order from the object.

The second lens group G2 (surface Nos. 6 through 14) is configured of a negative meniscus lens element 21 having the convex surface facing toward the object, a biconcave negative lens element 22, a biconvex positive lens element 23, and a negative meniscus lens element 24 having the convex surface facing toward the image, in that order from the object. The object-side surface of the negative meniscus lens element 21 has an aspherical layer that is made of a compound resin bonded thereto.

The third lens group G3 (surface Nos. 16 through 21) is configured of a biconvex positive lens element 31, a biconvex positive lens element 32, and a biconcave negative lens element 33, in that order from the object. A diaphragm S (surface No. 15) is provided between the second lens group G2 and the third lens group G3 and moves integrally with the third lens group G3.

The fourth lens group G4 (surface Nos. 22 through 26) is configured of a biconvex positive lens element 41, and a cemented lens C4 formed from a biconcave negative lens element 42 and a biconvex positive lens element 43, in that order from the object. The biconvex positive lens element 43 is provided with an aspherical surface on the image side thereof.

TABLE 1
SURFACE DATA

| Surf. No. | r | d | N (d) | νd |
|---|---|---|---|---|
| 1 | 124.250 | 1.800 | 1.84666 | 23.8 |
| 2 | 67.500 | 7.070 | 1.49700 | 81.6 |
| 3 | −632.116 | 0.240 | | |
| 4 | 53.659 | 4.730 | 1.72916 | 54.7 |
| 5 | 156.000 | d5 | | |
| 6* | 191.082 | 0.200 | 1.52972 | 42.7 |
| 7 | 111.000 | 1.250 | 1.83481 | 42.7 |
| 8 | 12.162 | 5.410 | | |
| 9 | −36.572 | 1.220 | 1.88300 | 40.8 |
| 10 | 48.983 | 0.520 | | |
| 11 | 29.058 | 3.690 | 1.84666 | 23.8 |
| 12 | −29.058 | 0.690 | | |
| 13 | −19.530 | 1.310 | 1.77250 | 49.6 |
| 14 | −106.300 | d14 | | |
| 15 (Diaphragm) | ∞ | 0.890 | | |
| 16 | 45.821 | 2.700 | 1.48749 | 70.4 |
| 17 | −45.821 | 0.500 | | |
| 18 | 30.000 | 3.130 | 1.48749 | 70.4 |
| 19 | −355.189 | 0.950 | | |
| 20 | −35.633 | 1.310 | 1.60562 | 43.7 |
| 21 | 525.000 | d21 | | |
| 22 | 18.210 | 4.590 | 1.45860 | 90.2 |
| 23 | −53.000 | 2.360 | | |
| 24 | −188.078 | 1.200 | 1.79952 | 42.2 |
| 25 | 12.734 | 5.340 | 1.58944 | 60.8 |
| 26* | −66.281 | — | | |

The asterisk (*) designates an aspherical surface which is rotationally symmetrical with respect to the optical axis.

TABLE 2
ZOOM LENS SYSTEM DATA
Zoom Ratio 7.06

| | Short-FLE | IFL | Long-FLE |
|---|---|---|---|
| FNO. | 3.42 | 5.07 | 5.78 |
| f | 18.60 | 70.11 | 131.28 |
| W | 38.65 | 11.16 | 6.04 |
| Y | 14.24 | 14.24 | 14.24 |
| fB | 38.423 | 65.232 | 76.562 |
| L | 118.15 | 159.05 | 177.95 |
| d5 | 2.426 | 34.354 | 46.482 |
| d14 | 18.025 | 6.013 | 1.901 |
| d21 | 8.176 | 2.347 | 1.900 |

Note:
Short-FLE designates Short Focal Length Extremity;
IFL designates Intermediate Focal Length;
Long-FLE designates Long Focal Length Extremity; and
S. No. designates a surface number

TABLE 3
Aspherical Surface Data (the aspherical surface coefficients not
indicated are zero (0.00)):

| S. | | | | | |
|---|---|---|---|---|---|
| No. | κ | A4 | A6 | A8 | A10 |
| 6 | 0.000 | 0.2470E−04 | −0.6878E−07 | 0.1528E−09 | 0.9162E−13 |
| 26 | 0.000 | 0.3676E−04 | 0.1095E−06 | 0.5285E−09 | |

TABLE 4
LENS GROUP DATA

| Lens Group | 1^{st} Surf. | Focal Length |
|---|---|---|
| 1 | 1 | 87.524 |
| 2 | 6 | −12.048 |
| 3 | 16 | 44.366 |
| 4 | 22 | 43.793 |

### Embodiment 2

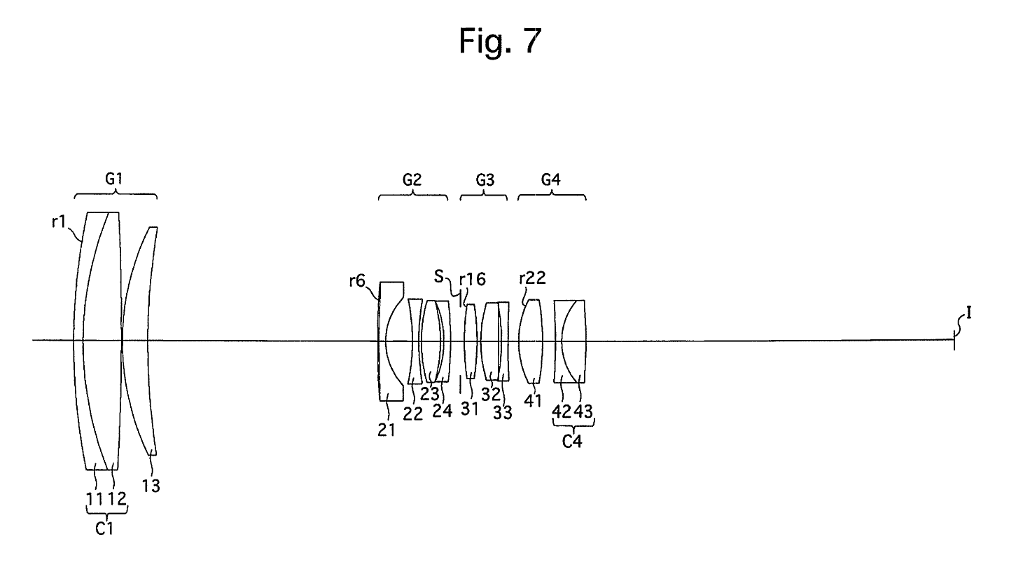

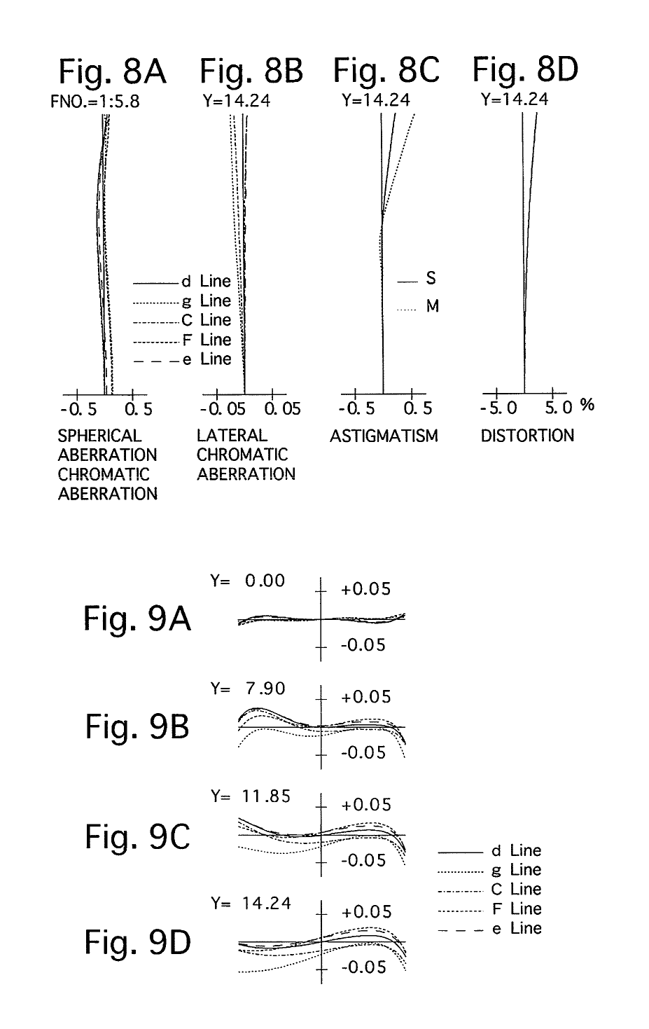

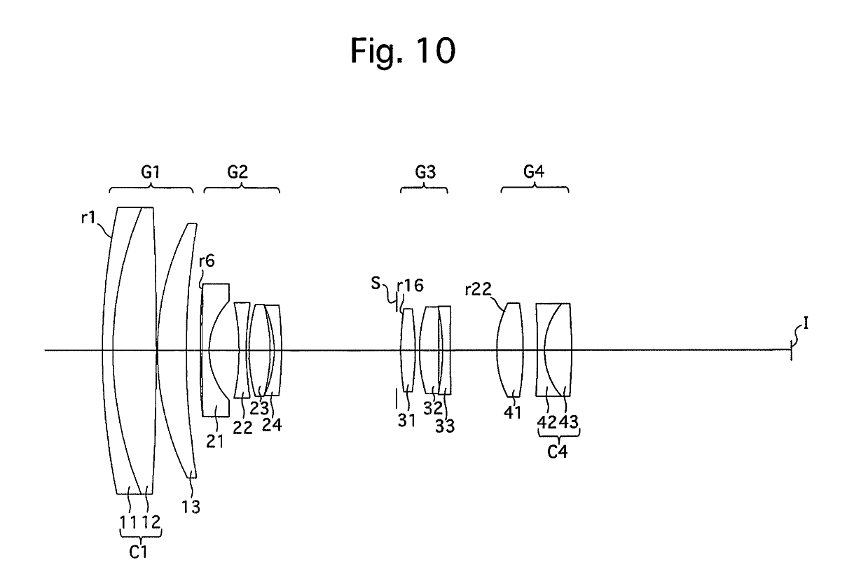

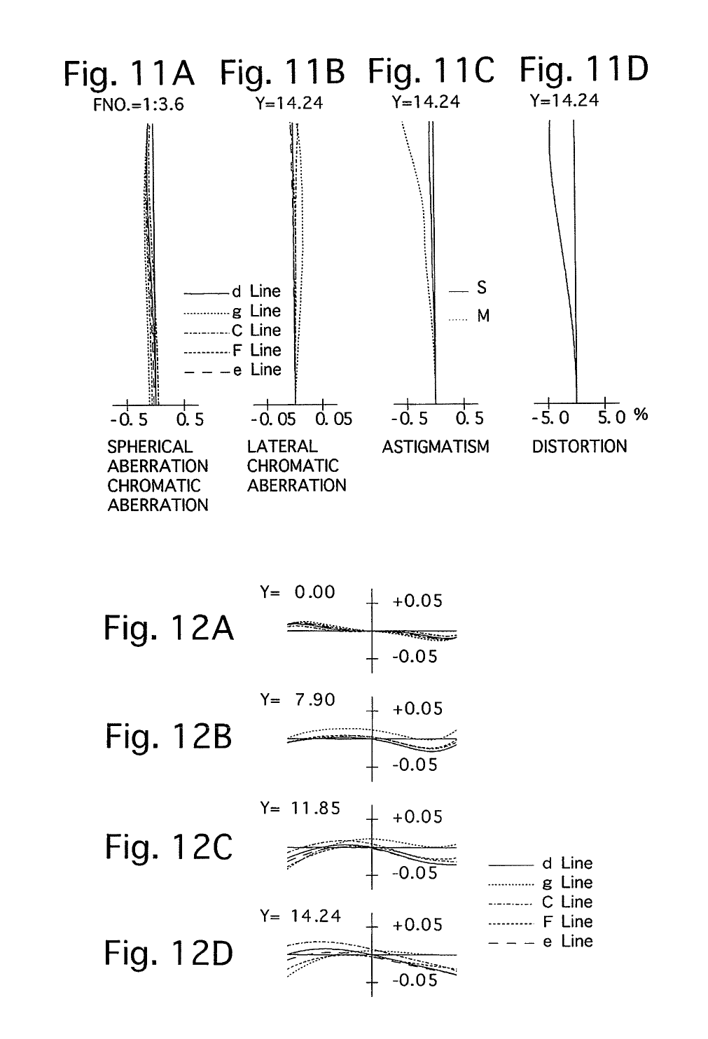

FIGS. 7 through 12D and Tables 5 through 8 show a second numerical embodiment of a high zoom-ratio zoom lens system according to the present invention. FIG. 7 shows a lens arrangement of the second numerical embodiment of the high zoom-ratio zoom lens system when an object at infinity is in an in-focus state at the long focal length extremity. FIGS. 8A, 8B, 8C and 8D show various aberrations that occurred in the lens arrangement shown in FIG. 7. FIGS. 9A, 9B, 9C and 9D show various lateral aberrations that occurred in the lens arrangement shown in FIG. 7. FIG. 10 shows a lens arrangement of the second numerical embodiment of the high zoom-ratio zoom lens system, according to the present invention, when an object at infinity is in an in-focus state at the short focal length extremity. FIGS. 11A, 11B, 11C and 11D show various aberrations that occurred in the lens arrangement shown in FIG. 10. FIGS. 12A, 12B, 12C and 12D show various lateral aberrations that occurred in the lens arrangement shown in FIG. 10. Table 5 shows the lens surface data, Table 6 shows various zoom lens system data, Table 7 shows the aspherical surface data, and Table 8 shows the lens group data of the zoom lens system according to second numerical embodiment.

The fundamental lens arrangement of the second numerical embodiment is the same as that of the first numerical embodiment except for the positive lens element 32 of the third lens group G3 being formed as a positive meniscus lens element having the convex surface facing toward on the object side.

TABLE 5
SURFACE DATA

| Surf. No. | r | d | N (d) | νd |
|---|---|---|---|---|
| 1 | 122.000 | 1.800 | 1.84666 | 23.8 |
| 2 | 65.000 | 7.480 | 1.49700 | 81.6 |
| 3 | −456.918 | 0.150 | | |
| 4 | 49.477 | 4.940 | 1.72916 | 54.7 |
| 5 | 135.029 | d5 | | |
| 6* | −900.000 | 0.200 | 1.52972 | 42.7 |
| 7 | 315.412 | 1.250 | 1.83481 | 42.7 |
| 8 | 12.538 | 5.170 | | |
| 9 | −41.300 | 1.220 | 1.88300 | 40.8 |
| 10 | 48.983 | 0.500 | | |
| 11 | 29.750 | 3.650 | 1.84666 | 23.8 |
| 12 | −29.750 | 0.670 | | |
| 13 | −19.380 | 1.250 | 1.77250 | 49.6 |
| 14 | −73.562 | d14 | | |
| 15 (Diaphragm) | ∞ | 0.700 | | |
| 16 | 48.983 | 2.460 | 1.48749 | 70.4 |
| 17 | −48.983 | 0.740 | | |
| 18 | 26.819 | 3.350 | 1.48749 | 70.4 |
| 19 | 1382.845 | 0.620 | | |
| 20 | −38.823 | 1.300 | 1.60562 | 43.7 |
| 21 | 334.800 | d21 | | |
| 22 | 18.330 | 4.600 | 1.45860 | 90.2 |
| 23 | −48.350 | 2.460 | | |
| 24 | −132.321 | 1.200 | 1.79952 | 42.2 |
| 25 | 12.538 | 4.690 | 1.58944 | 60.8 |
| 26* | −65.106 | — | | |

The asterisk (*) designates an aspherical surface which is rotationally symmetrical with respect to the optical axis.

TABLE 6
ZOOM LENS SYSTEM DATA
Zoom Ratio 7.04

| | Short-FLE | IFL | Long-FLE |
|---|---|---|---|
| FNO. | 3.60 | 5.15 | 5.76 |
| f | 18.60 | 70.09 | 130.98 |
| W | 38.65 | 11.17 | 6.05 |
| Y | 14.24 | 14.24 | 14.24 |
| fB | 37.702 | 61.386 | 70.7 |
| L | 118.39 | 153.99 | 169.12 |
| d5 | 2.462 | 33.089 | 44.124 |
| d14 | 19.836 | 6.740 | 1.900 |
| d21 | 7.989 | 2.378 | 2.000 |

TABLE 7
Aspherical Surface Data (the aspherical surface coefficients not
indicated are zero (0.00)):

| S. No. | κ | A4 | A6 | A8 | A10 |
|---|---|---|---|---|---|
| 6 | 0.000 | 0.3465E−04 | −0.1119E−06 | 0.3649E−09 | −0.4625E−12 |
| 26 | 0.000 | 0.3874E−04 | 0.9610E−07 | 0.6357E−09 | |

TABLE 8
LENS GROUP DATA

| Lens Group | 1^{st} Surf. | Focal Length |
|---|---|---|
| 1 | 1 | 82.444 |
| 2 | 6 | −12.515 |
| 3 | 16 | 45.306 |
| 4 | 22 | 45.486 |

### Embodiment 3

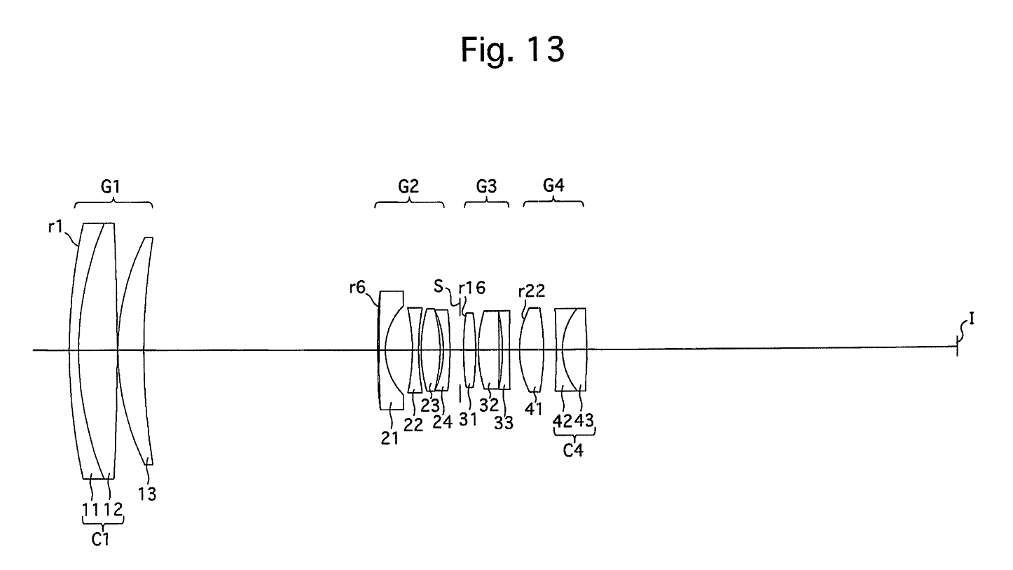

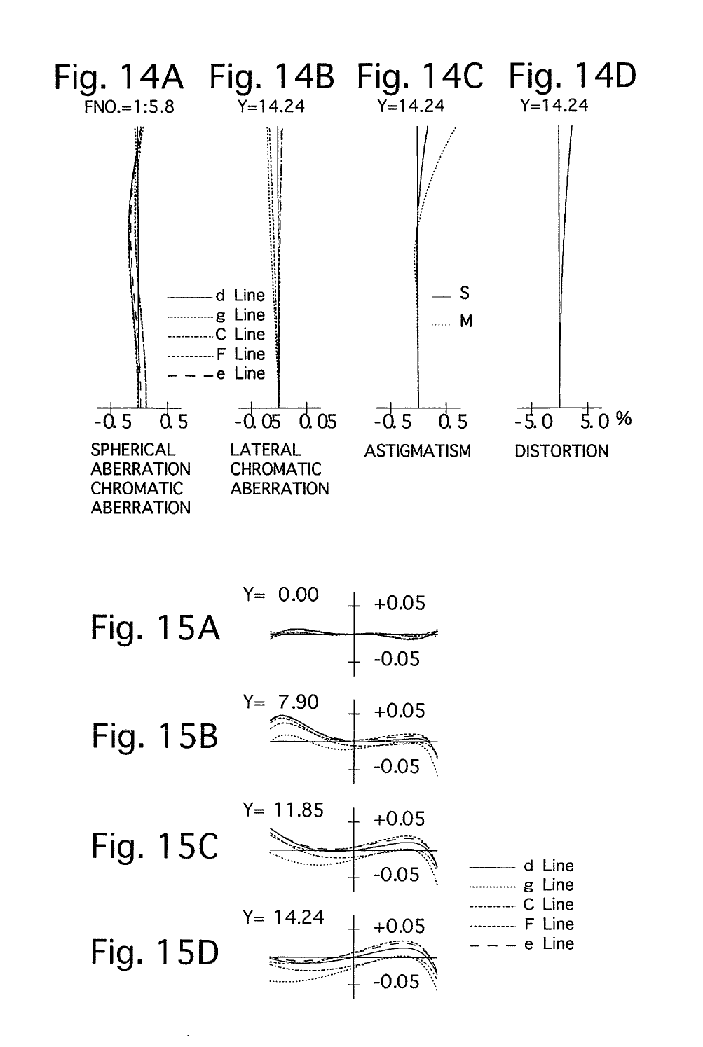

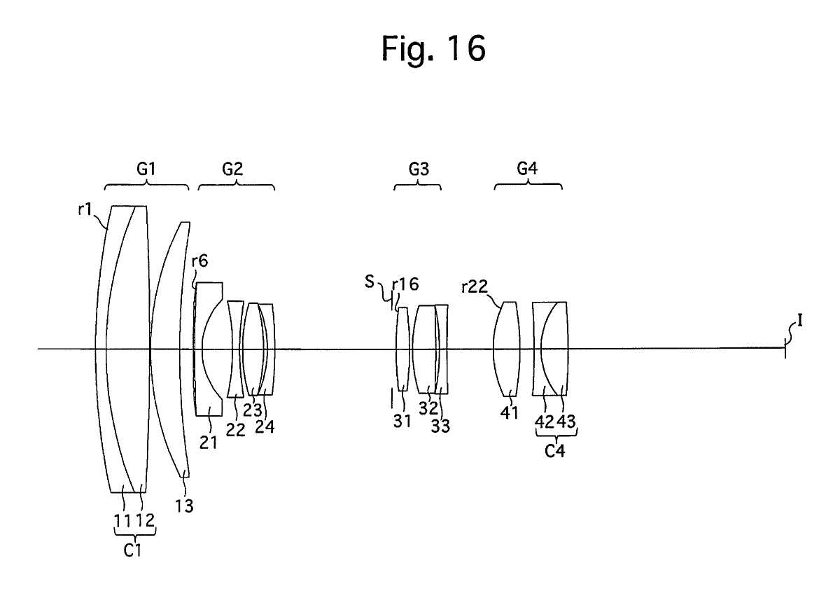

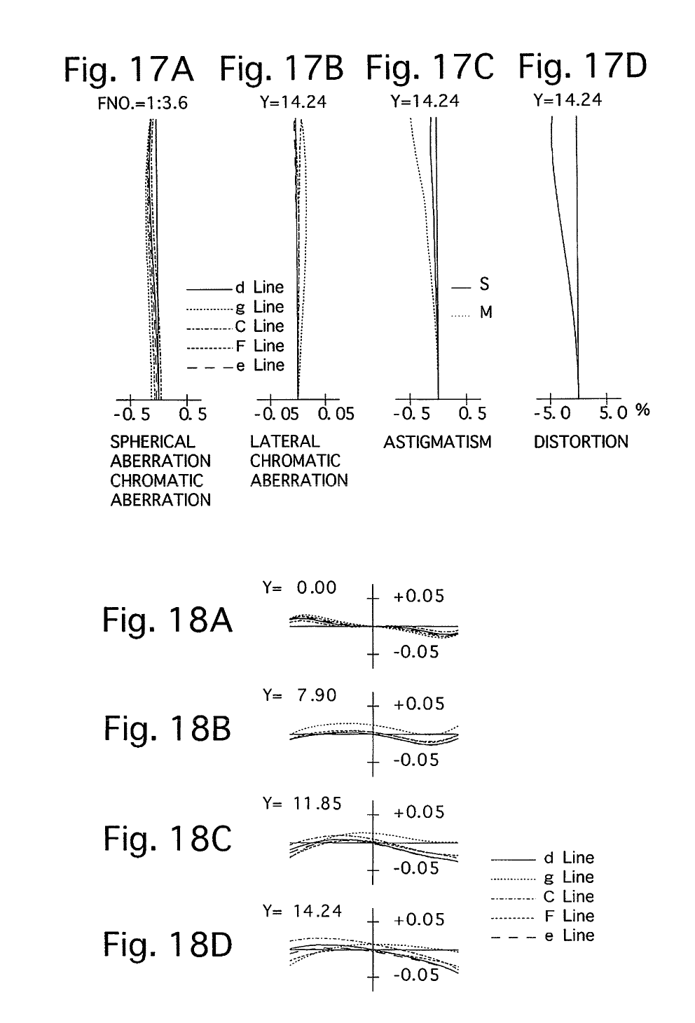

FIGS. 13 through 18D and Tables 9 through 12 show a third numerical embodiment of a high zoom-ratio zoom lens system according to the present invention. FIG. 13 shows a lens arrangement of the third numerical embodiment of the high zoom-ratio zoom lens system when an object at infinity is in an in-focus state at the long focal length extremity. FIGS. 14A, 14B, 14C and 14D show various aberrations that occurred in the lens arrangement shown in FIG. 13. FIGS. 15A, 15B, 15C and 15D show various lateral aberrations that occurred in the lens arrangement shown in FIG. 13. FIG. 16 shows a lens arrangement of the third numerical embodiment of the high zoom-ratio zoom lens system, according to the present invention when an object at infinity is in an in-focus state at the short focal length extremity. FIGS. 17A, 17B, 17C and 17D show various aberrations that occurred in the lens arrangement shown in FIG. 16. FIGS. 18A, 18B, 18C and 18D show various lateral aberrations that occurred in the lens arrangement shown in FIG. 16. Table 9 shows the lens surface data, Table 10 shows various zoom lens system data, Table 11 shows the aspherical surface data, and Table 12 shows the lens group data of the zoom lens system according to third numerical embodiment.

The fundamental lens arrangement of the third numerical embodiment is the same as that of the first numerical embodiment.

TABLE 9
SURFACE DATA

| Surf. No. | r | d | N (d) | νd |
|---|---|---|---|---|
| 1 | 114.856 | 1.800 | 1.84666 | 23.8 |
| 2 | 64.567 | 7.443 | 1.45860 | 90.2 |
| 3 | −496.229 | 0.150 | | |
| 4 | 49.577 | 4.972 | 1.72916 | 54.7 |
| 5 | 138.507 | d5 | | |
| 6* | 980.681 | 0.200 | 1.52972 | 42.7 |
| 7 | 196.740 | 1.250 | 1.83481 | 42.7 |
| 8 | 12.553 | 5.209 | | |
| 9 | −40.032 | 1.220 | 1.88300 | 40.8 |
| 10 | 48.911 | 0.500 | | |
| 11 | 29.825 | 3.620 | 1.84666 | 23.8 |
| 12 | −30.004 | 0.670 | | |
| 13 | −19.359 | 1.250 | 1.77250 | 49.6 |
| 14 | −70.966 | d14 | | |
| 15 (Diaphragm) | ∞ | 0.700 | | |
| 16 | 55.010 | 2.340 | 1.48749 | 70.4 |
| 17 | −54.654 | 0.500 | | |
| 18 | 25.960 | 4.021 | 1.48749 | 70.4 |
| 19 | −191.137 | 0.620 | | |
| 20 | −38.473 | 1.300 | 1.60562 | 43.7 |
| 21 | 225.620 | d21 | | |
| 22 | 18.904 | 4.600 | 1.45860 | 90.2 |
| 23 | −46.666 | 2.458 | | |
| 24 | −125.405 | 1.200 | 1.79952 | 42.2 |
| 25 | 12.942 | 4.699 | 1.58944 | 60.8 |
| 26* | −66.182 | — | | |

The asterisk (*) designates an aspherical surface which is rotationally symmetrical with respect to the optical axis.

TABLE 10
ZOOM LENS SYSTEM DATA
Zoom Ratio 7.04

| | Short-FLE | IFL | Long-FLE |
|---|---|---|---|
| FNO. | 3.60 | 5.15 | 5.78 |
| f | 18.60 | 70.00 | 131.01 |
| W | 38.66 | 11.21 | 6.06 |
| Y | 14.24 | 14.24 | 14.24 |
| fB | 37.27 | 61.28 | 70.979 |
| L | 118.40 | 154.61 | 170.46 |
| d5 | 2.350 | 33.508 | 44.857 |
| d14 | 20.098 | 6.754 | 1.900 |
| d21 | 7.957 | 2.345 | 2.000 |

TABLE 11
Aspherical Surface Data (the aspherical surface coefficients
not indicated are zero (0.00)):

| S. | | | | | |
|---|---|---|---|---|---|
| No. | κ | A4 | A6 | A8 | A10 |
| 6 | 0.000 | 0.3010E−04 | −0.6985E−07 | 0.1393E−09 | 0.9041E−13 |
| 26 | 0.000 | 0.3788E−04 | 0.1241E−06 | 0.3575E−09 | |

TABLE 12
LENS GROUP DATA

| Lens Group | 1^{st} Surf. | Focal Length |
|---|---|---|
| 1 | 1 | 84.218 |
| 2 | 6 | −12.691 |
| 3 | 16 | 44.384 |
| 4 | 22 | 46.392 |

### Embodiment 4

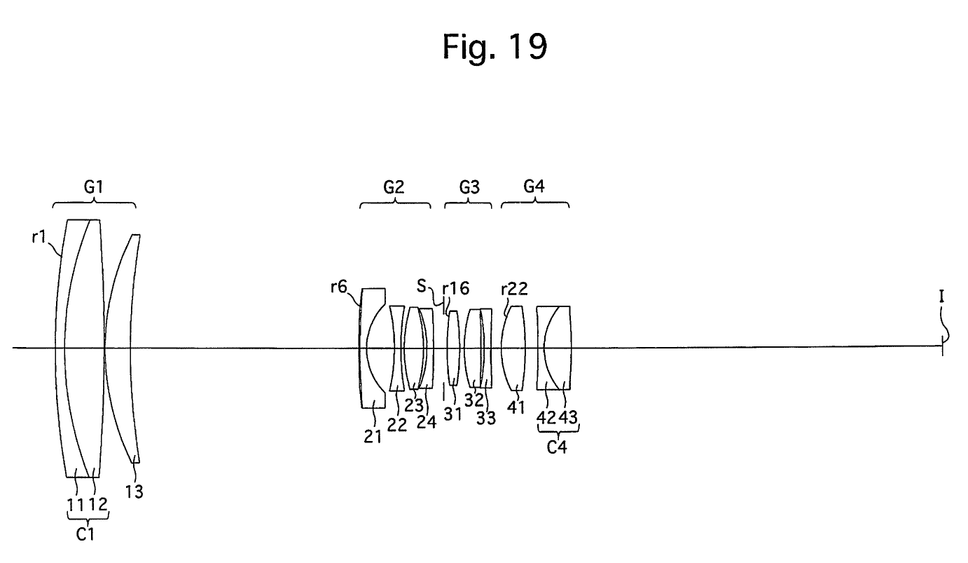

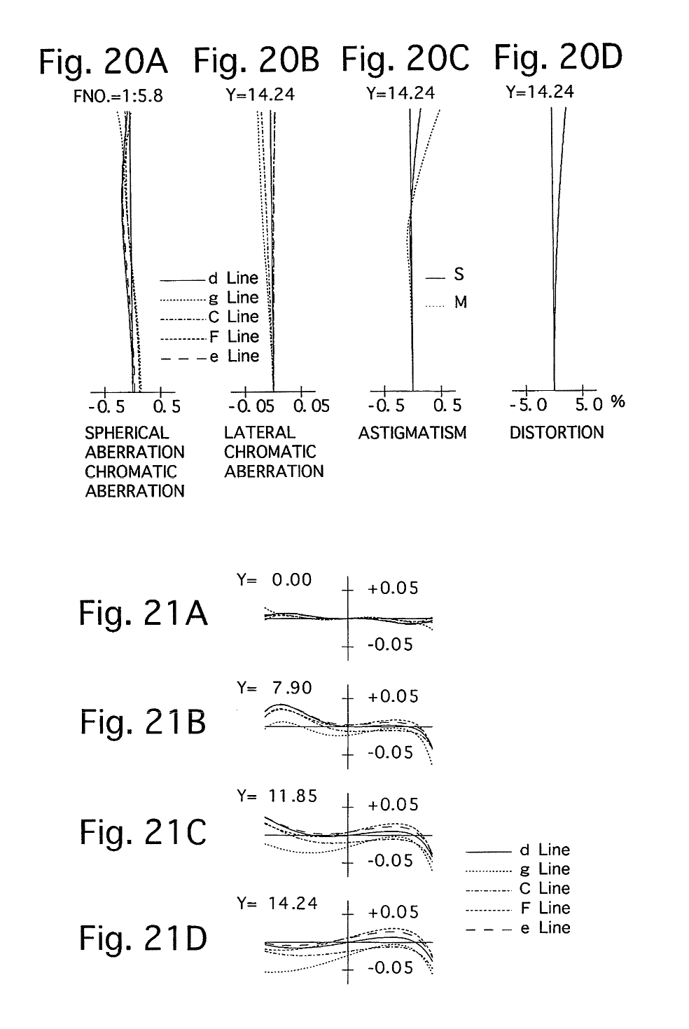

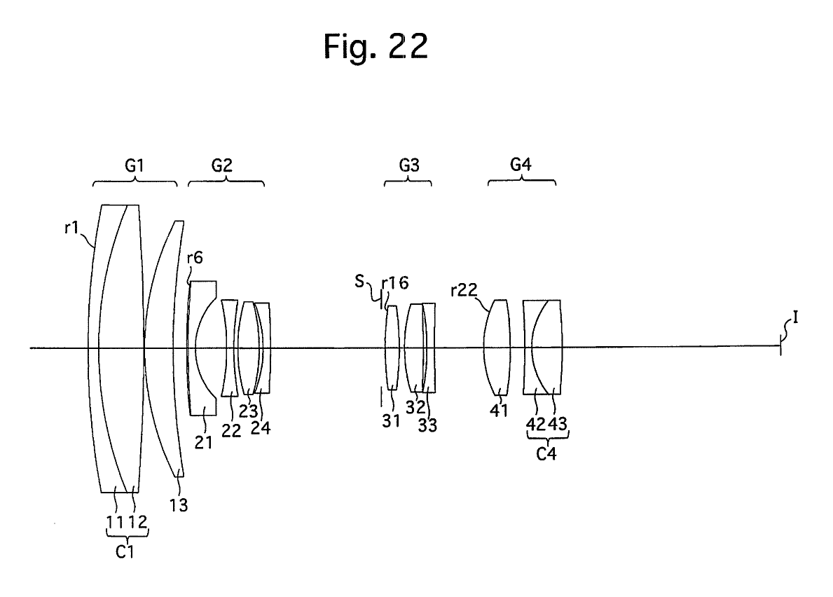

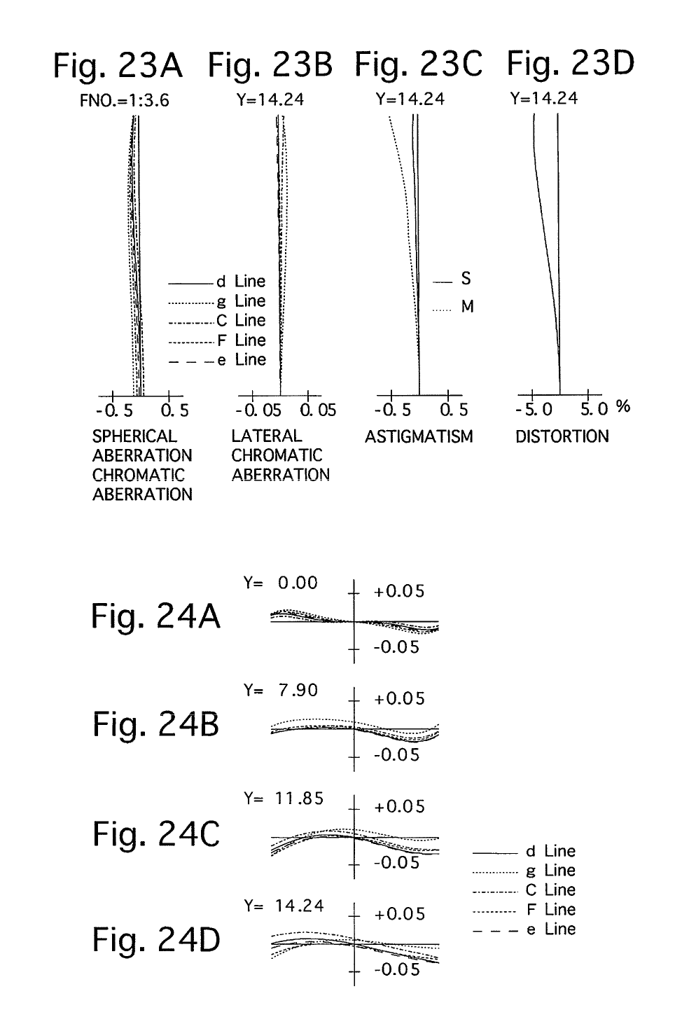

FIGS. 19 through 24D and Tables 13 through 16 show a fourth numerical embodiment of a high zoom-ratio zoom lens system according to the present invention. FIG. 19 shows a lens arrangement of the fourth numerical embodiment of the high zoom-ratio zoom lens system when an object at infinity is in an in-focus state at the long focal length extremity. FIGS. 20A, 20B, 20C and 20D show various aberrations that occurred in the lens arrangement shown in FIG. 19. FIGS. 21A, 21B, 21C and 21D show various lateral aberrations that occurred in the lens arrangement shown in FIG. 19. FIG. 22 shows a lens arrangement of the fourth numerical embodiment of the high zoom-ratio zoom lens system, according to the present invention when an object at infinity is in an in-focus state at the short focal length extremity. FIGS. 23A, 23B, 23C and 23D show various aberrations that occurred in the lens arrangement shown in FIG. 22. FIGS. 24A, 24B, 24C and 24D show various lateral aberrations that occurred in the lens arrangement shown in FIG. 22. Table 13 shows the lens surface data, Table 14 shows various zoom lens system data, Table 15 shows the aspherical surface data, and Table 16 shows the lens group data of the zoom lens system according to fourth numerical embodiment.

The fundamental lens arrangement of the fourth numerical embodiment is the same as that of the first numerical embodiment.

TABLE 13
SURFACE DATA

| Surf. No. | r | d | N (d) | νd |
|---|---|---|---|---|
| 1 | 137.272 | 1.800 | 1.84666 | 23.8 |
| 2 | 65.867 | 7.659 | 1.49700 | 81.6 |
| 3 | −330.000 | 0.150 | | |
| 4 | 49.229 | 4.884 | 1.77250 | 49.6 |
| 5 | 128.547 | d5 | | |
| 6* | 218.224 | 0.200 | 1.52972 | 42.7 |
| 7 | 134.450 | 1.250 | 1.83481 | 42.7 |
| 8 | 12.370 | 5.355 | | |
| 9 | −37.200 | 1.220 | 1.88300 | 40.8 |
| 10 | 48.983 | 0.666 | | |
| 11 | 29.592 | 3.668 | 1.84666 | 23.8 |
| 12 | −29.592 | 0.670 | | |
| 13 | −20.750 | 1.250 | 1.77250 | 49.6 |
| 14 | −142.289 | d14 | | |
| 15 (Diaphragm) | ∞ | 0.700 | | |
| 16 | 51.555 | 2.402 | 1.48749 | 70.4 |
| 17 | −51.555 | 0.877 | | |
| 18 | 26.975 | 3.214 | 1.48749 | 70.4 |
| 19 | −155.860 | 0.620 | | |
| 20 | −38.590 | 1.300 | 1.60562 | 43.7 |
| 21 | 265.000 | d21 | | |
| 22 | 18.660 | 4.600 | 1.45860 | 90.2 |
| 23 | −51.786 | 2.460 | | |
| 24 | −129.709 | 1.200 | 1.79952 | 42.2 |
| 25 | 12.690 | 5.241 | 1.58944 | 60.8 |
| 26* | −63.424 | — | | |

The asterisk (*) designates an aspherical surface which is rotationally symmetrical with respect to the optical axis.

TABLE 14
ZOOM LENS SYSTEM DATA
Zoom Ratio 7.05

| | Short-FLE | IFL | Long-FLE |
|---|---|---|---|
| FNO. | 3.60 | 5.17 | 5.77 |
| f | 18.60 | 70.08 | 131.11 |
| W | 38.65 | 11.17 | 6.05 |
| Y | 14.24 | 14.24 | 14.24 |
| fB | 37.431 | 61.883 | 71.245 |
| L | 118.57 | 154.79 | 170.25 |
| d5 | 2.355 | 32.693 | 43.766 |
| d14 | 18.958 | 6.452 | 1.900 |
| d21 | 8.438 | 2.374 | 1.950 |

TABLE 15
Aspherical Surface Data (the aspherical surface
coefficients not indicated are zero (0.00)):

| S. No. | K | A4 | A6 | A8 |
|---|---|---|---|---|
| 6 | 0.000 | 0.2148E−04 | −0.6401E−07 | 0.1564E−09 |
| | | A10 | | |
| | | −0.1698E−12 | | |
| S. No. | K | A4 | A6 | A8 |
| 26 | 0.000 | 0.3627E−04 | 0.9712E−07 | 0.3933E−09 |

TABLE 16
LENS GROUP DATA

| Lens Group | 1^{st} Surf. | Focal Length |
|---|---|---|
| 1 | 1 | 81.604 |
| 2 | 6 | −12.102 |
| 3 | 16 | 42.496 |
| 4 | 22 | 47.282 |

### Embodiment 5

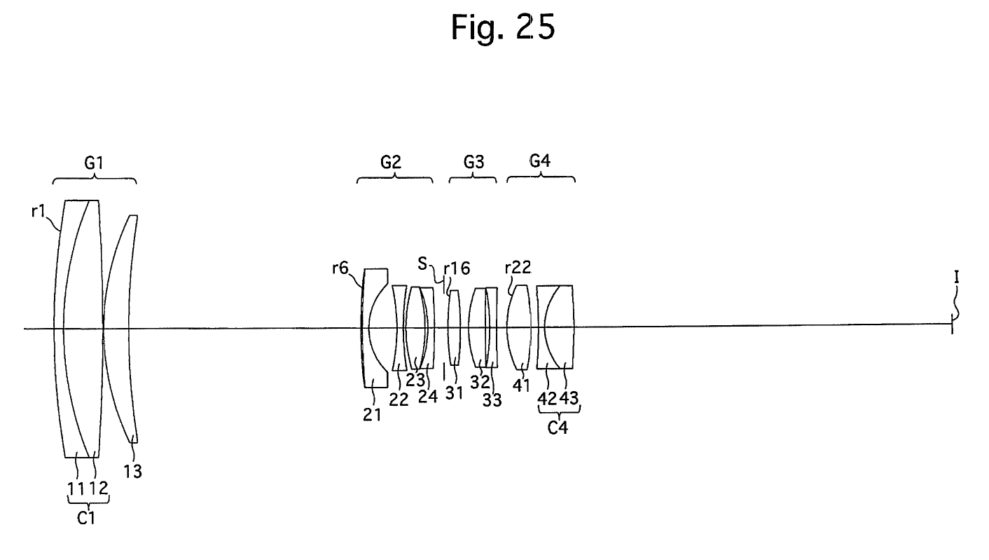

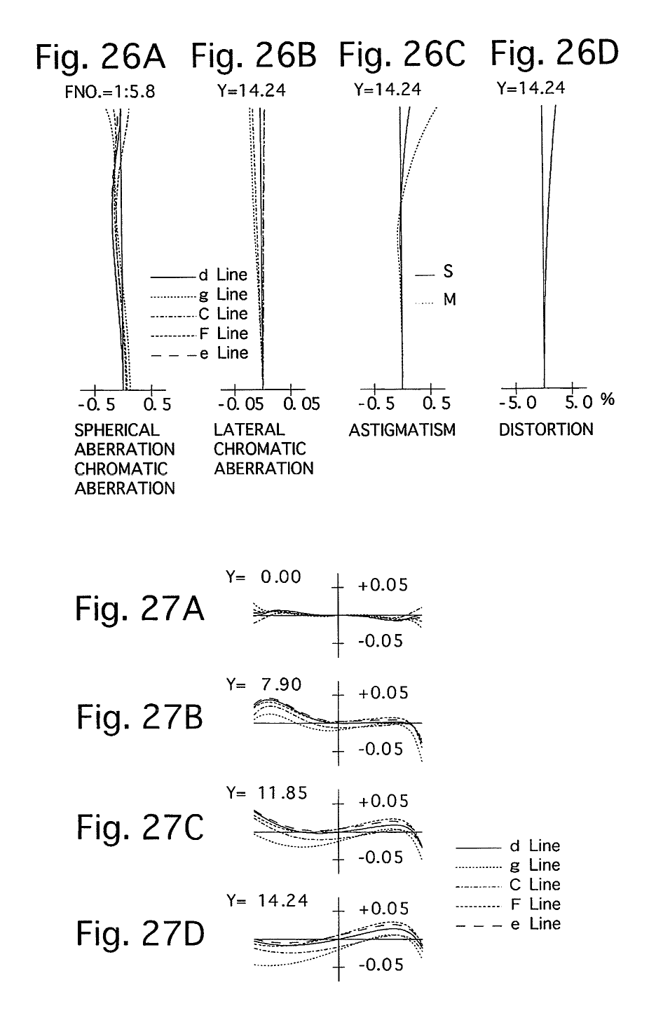

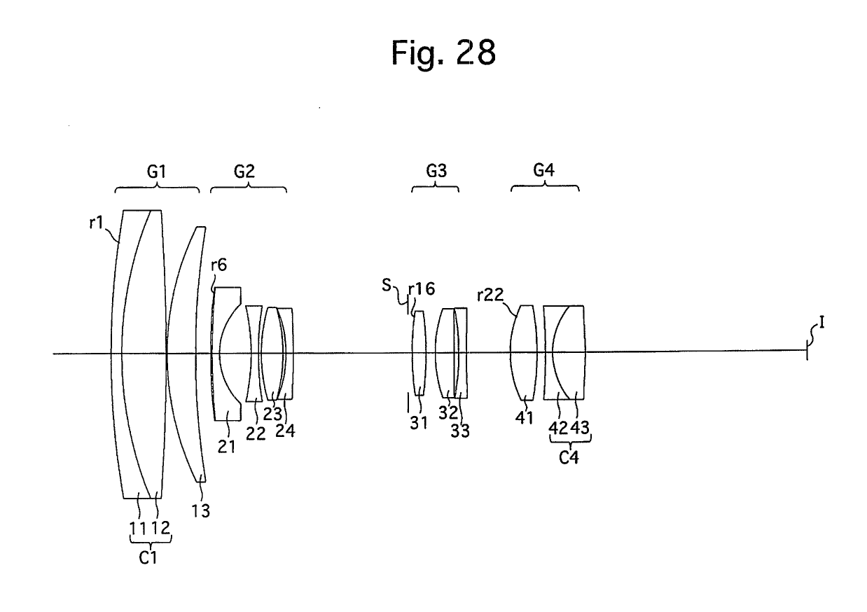

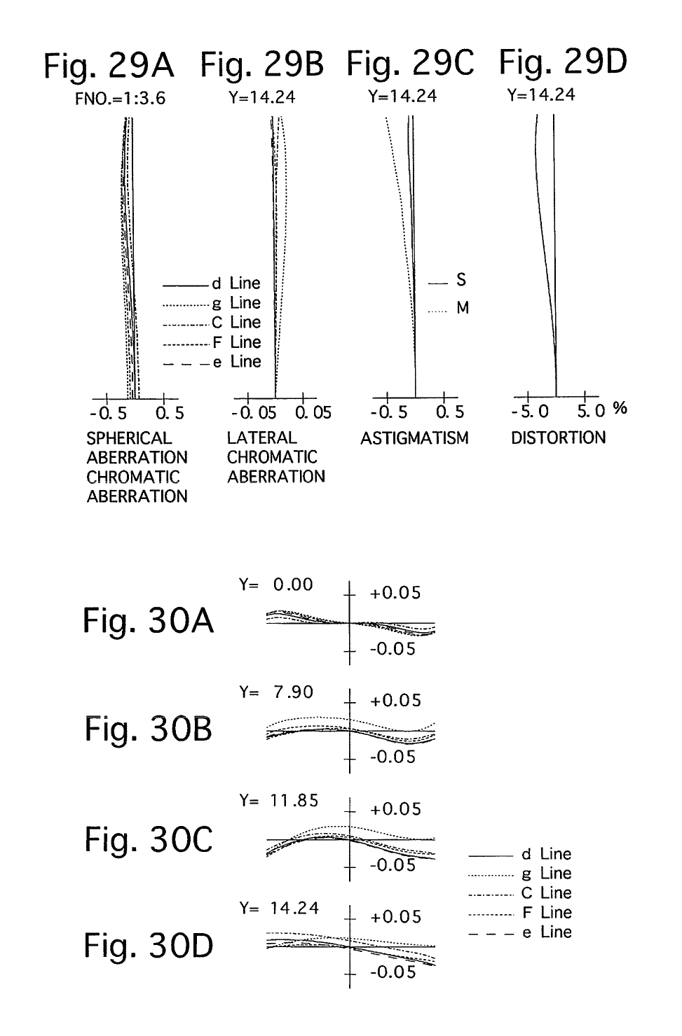

FIGS. 25 through 30D and Tables 17 through 20 show a fifth numerical embodiment of a high zoom-ratio zoom lens system according to the present invention. FIG. 25 shows a lens arrangement of the fifth numerical embodiment of the high zoom-ratio zoom lens system when an object at infinity is in an in-focus state at the long focal length extremity. FIGS. 26A, 26B, 26C and 26D show various aberrations that occurred in the lens arrangement shown in FIG. 25. FIGS. 27A, 27B, 27C and 27D show various lateral aberrations that occurred in the lens arrangement shown in FIG. 25. FIG. 28 shows a lens arrangement of the fifth numerical embodiment of the high zoom-ratio zoom lens system, according to the present invention when an object at infinity is in an in-focus state at the short focal length extremity. FIGS. 29A, 29B, 29C and 29D show various aberrations that occurred in the lens arrangement shown in FIG. 28. FIGS. 30A, 30B, 30C and 30D show various lateral aberrations that occurred in the lens arrangement shown in FIG. 28. Table 17 shows the lens surface data, Table 18 shows various zoom lens system data, Table 19 shows the aspherical surface data, and Table 20 shows the lens group data of the zoom lens system according to fifth numerical embodiment.

The fundamental lens arrangement of the fifth numerical embodiment is the same as that of the second numerical embodiment.

TABLE 17
SURFACE DATA

| Surf. No. | r | d | N(d) | νd |
|---|---|---|---|---|
| 1 | 144.905 | 1.800 | 1.84666 | 23.8 |
| 2 | 64.750 | 7.584 | 1.49700 | 81.6 |
| 3 | −363.162 | 0.150 | | |
| 4 | 50.775 | 4.843 | 1.80420 | 46.5 |
| 5 | 138.824 | d5 | | |
| 6 * | 196.789 | 0.200 | 1.52972 | 42.7 |
| 7 | 121.212 | 1.250 | 1.83481 | 42.7 |
| 8 | 12.064 | 5.417 | | |
| 9 | −37.692 | 1.220 | 1.88300 | 40.8 |
| 10 | 49.000 | 0.509 | | |
| 11 | 28.817 | 3.706 | 1.84666 | 23.8 |
| 12 | −29.438 | 0.533 | | |
| 13 | −21.008 | 1.250 | 1.77250 | 49.6 |
| 14 | −128.550 | d14 | | |
| 15 (Diaphragm) | ∞ | 0.700 | | |
| 16 | 48.457 | 2.412 | 1.48749 | 70.4 |
| 17 | −55.694 | 1.561 | | |
| 18 | 22.837 | 3.229 | 1.48749 | 70.4 |
| 19 | 599.295 | 0.837 | | |
| 20 | −41.303 | 1.300 | 1.61039 | 46.6 |
| 21 | 224.616 | d21 | | |
| 22 | 19.010 | 4.625 | 1.49019 | 83.1 |
| 23 | −44.441 | 1.447 | | |
| 24 | −94.135 | 1.200 | 1.80900 | 44.1 |
| 25 | 12.525 | 5.614 | 1.59000 | 67.0 |
| 26 * | −66.333 | — | | |

The asterisk (*) designates an aspherical surface which is rotationally symmetrical with respect to the optical axis.

TABLE 18
ZOOM LENS SYSTEM DATA
Zoom Ratio 7.04

| | Short-FLE | IFL | Long-FLE |
|---|---|---|---|
| FNO. | 3.60 | 5.16 | 5.77 |
| f | 18.60 | 70.00 | 131.01 |
| W | 38.25 | 11.18 | 6.05 |
| Y | 14.24 | 14.24 | 14.24 |
| fB | 37.865 | 62.969 | 72.513 |
| L | 119.08 | 156.52 | 172.44 |
| d5 | 2.632 | 33.229 | 44.642 |
| d14 | 19.654 | 6.556 | 1.900 |
| d21 | 7.537 | 2.379 | 2.000 |

TABLE 19
Aspherical Surface Data (the aspherical surface
coefficients not indicated are zero (0.00)):

| S. No. | K | A4 | A6 | A8 |
|---|---|---|---|---|
| 6 | 0.000 | 0.2308E−04 | −0.3896E−07 | −0.9504E−10 |
| | | A10 | | |
| | | 0.6039E−12 | | |
| S. No. | K | A4 | A6 | A8 |
| 26 | 0.000 | 0.3874E−04 | 0.1161E−06 | 0.2772E−09 |

TABLE 20
LENS GROUP DATA

| Lens Group | 1^{st} Surf. | Focal Length |
|---|---|---|
| 1 | 1 | 82.884 |
| 2 | 6 | −12.382 |
| 3 | 16 | 42.123 |
| 4 | 21 | 48.187 |

### Embodiment 6

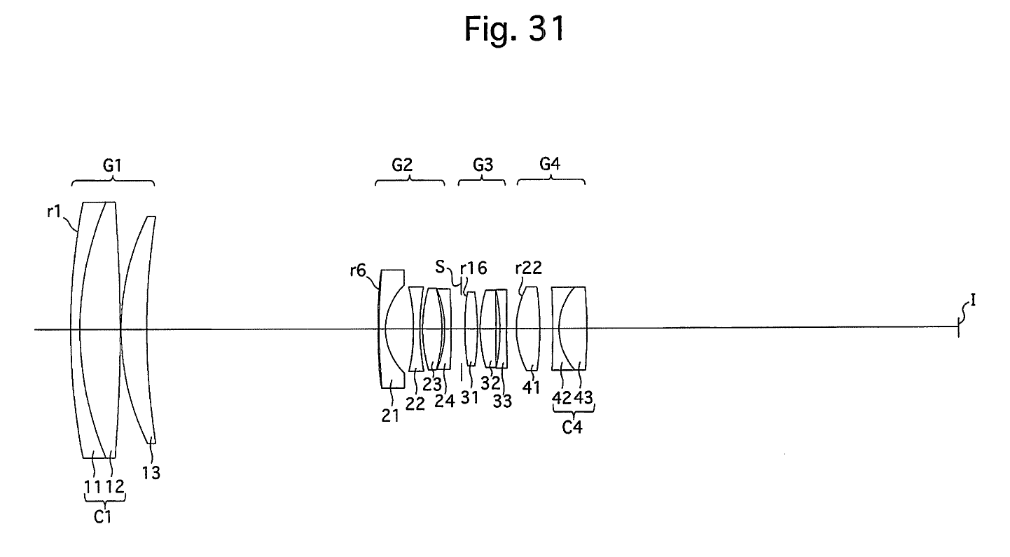

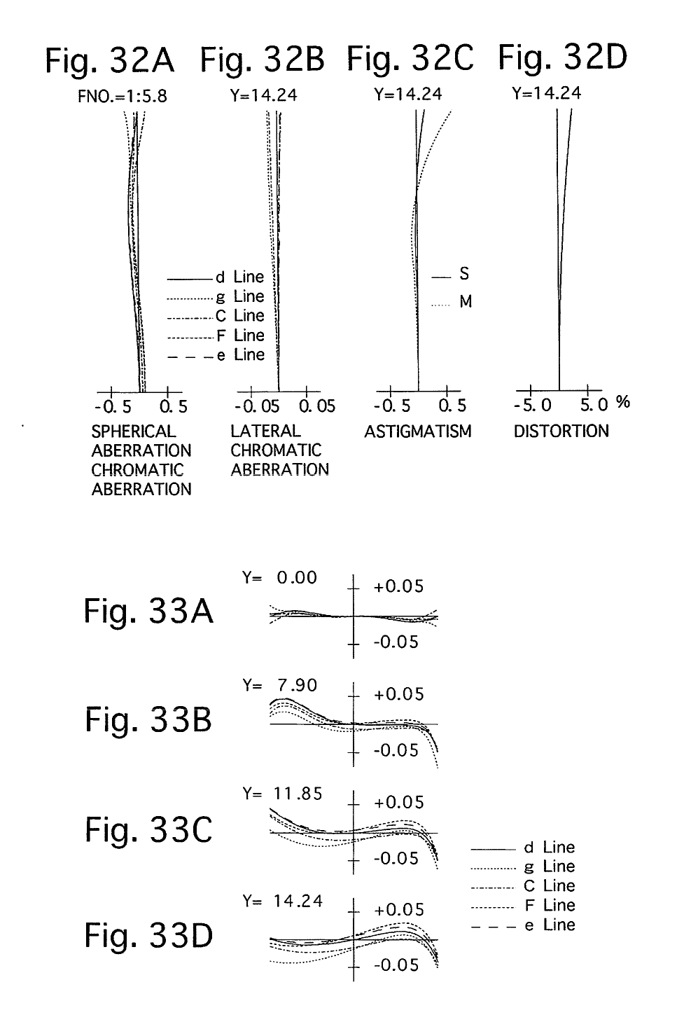

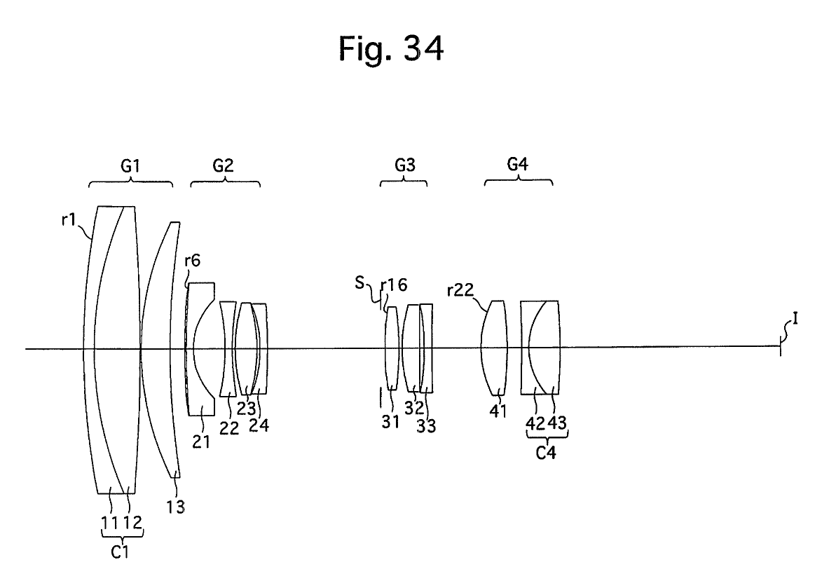

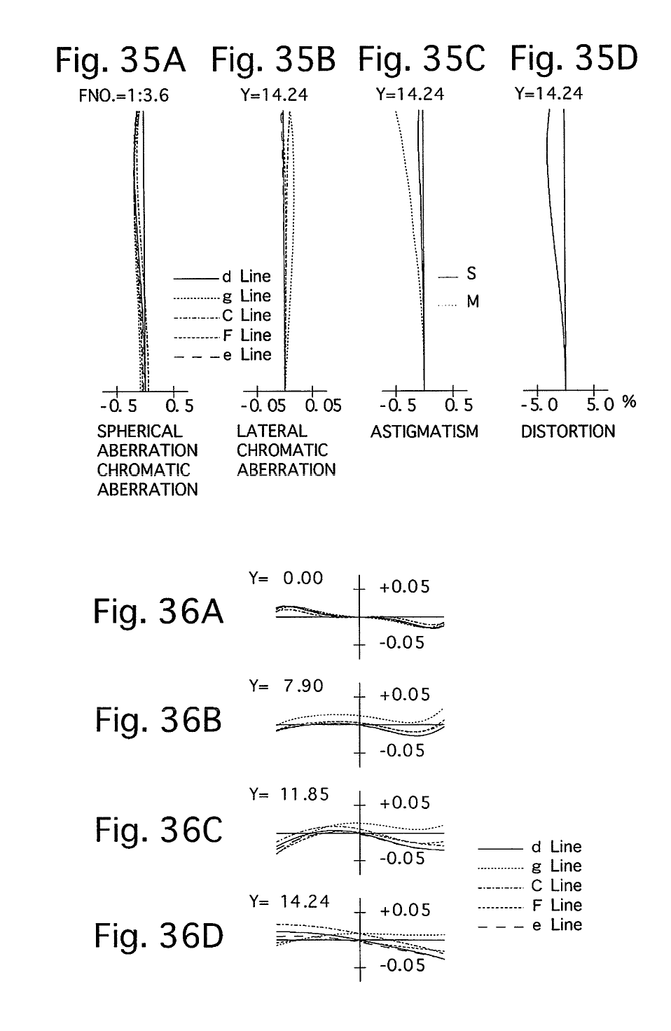

FIGS. 31 through 36D and Tables 21 through 24 show a sixth numerical embodiment of a high zoom-ratio zoom lens system according to the present invention. FIG. 31 shows a lens arrangement of the sixth numerical embodiment of the high zoom-ratio zoom lens system when an object at infinity is in an in-focus state at the long focal length extremity. FIGS. 32A, 32B, 32C and 32D show various aberrations that occurred in the lens arrangement shown in FIG. 31. FIGS. 33A, 33B, 33C and 33D show various lateral aberrations that occurred in the lens arrangement shown in FIG. 31. FIG. 34 shows a lens arrangement of the sixth numerical embodiment of the high zoom-ratio zoom lens system, according to the present invention when an object at infinity is in an in-focus state at the short focal length extremity. FIGS. 35A, 35B, 35C and 35D show various aberrations that occurred in the lens arrangement shown in FIG. 31. FIGS. 36A, 36B, 36C and 36D show various lateral aberrations that occurred in the lens arrangement shown in FIG. 34. Table 21 shows the lens surface data, Table 22 shows various zoom lens system data, Table 23 shows the aspherical surface data, and Table 24 shows the lens group data of the zoom lens system according to sixth numerical embodiment.

The fundamental lens arrangement of the sixth numerical embodiment is the same as that of the first numerical embodiment.

TABLE 21
SURFACE DATA

| Surf. No. | r | d | N(d) | νd |
|---|---|---|---|---|
| 1 | 127.900 | 1.800 | 1.84666 | 23.8 |
| 2 | 62.752 | 7.847 | 1.44000 | 95.2 |
| 3 | −318.523 | 0.150 | | |
| 4 | 50.016 | 4.965 | 1.80400 | 46.6 |
| 5 | 141.791 | d5 | | |
| 6 * | 200.333 | 0.200 | 1.52972 | 42.7 |
| 7 | 121.939 | 1.250 | 1.83481 | 42.7 |
| 8 | 11.997 | 5.429 | | |
| 9 | −37.692 | 1.220 | 1.88300 | 40.8 |
| 10 | 49.000 | 0.500 | | |
| 11 | 28.894 | 3.705 | 1.84666 | 23.8 |
| 12 | −29.397 | 0.535 | | |
| 13 | −20.970 | 1.250 | 1.77250 | 49.6 |
| 14 | −119.651 | d14 | | |
| 15 (Diaphragm) | ∞ | 0.700 | | |
| 16 | 48.881 | 2.425 | 1.48749 | 70.4 |
| 17 | −52.609 | 0.527 | | |
| 18 | 27.041 | 3.041 | 1.48749 | 70.4 |
| 19 | −1638.485 | 0.770 | | |
| 20 | −40.228 | 1.300 | 1.60562 | 43.7 |
| 21 | 346.525 | d21 | | |
| 22 | 18.212 | 4.507 | 1.46133 | 89.6 |
| 23 | −60.696 | 2.498 | | |
| 24 | −205.229 | 1.200 | 1.80335 | 41.7 |
| 25 | 12.275 | 5.420 | 1.58944 | 60.8 |
| 26 * | −63.485 | — | | |

The asterisk (*) designates an aspherical surface which is rotationally symmetrical with respect to the optical axis.

TABLE 22
ZOOM LENS SYSTEM DATA
Zoom Ratio 7.06

| | Short-FLE | IFL | Long-FLE |
|---|---|---|---|
| FNO. | 3.60 | 5.21 | 5.79 |
| f | 18.60 | 70.09 | 131.24 |
| W | 38.16 | 11.17 | 6.04 |
| Y | 14.24 | 14.24 | 14.24 |
| fB | 37.818 | 62.597 | 71.566 |
| L | 119.48 | 155.46 | 170.99 |
| d5 | 2.543 | 32.863 | 44.384 |
| d14 | 19.422 | 6.550 | 1.900 |
| d21 | 8.457 | 2.206 | 1.900 |

TABLE 23
Aspherical Surface Data (the aspherical surface
coefficients not indicated are zero (0.00)):

| S. No. | K | A4 | A6 | A8 |
|---|---|---|---|---|
| 6 | 0.000 | 0.2301E−04 | −0.2906E−07 | −0.1716E−09 |
| | | A10 | | |
| | | 0.8056E−12 | | |
| S. No. | K | A4 | A6 | A8 |
| 26 | 0.000 | 0.3482E−04 | 0.1176E−06 | 0.2309E−09 |

TABLE 24
LENS GROUP DATA

| Lens Group | 1^{st} Surf. | Focal Length |
|---|---|---|
| 1 | 1 | 82.304 |
| 2 | 6 | −12.393 |
| 3 | 16 | 44.806 |
| 4 | 22 | 45.685 |

### Embodiment 7

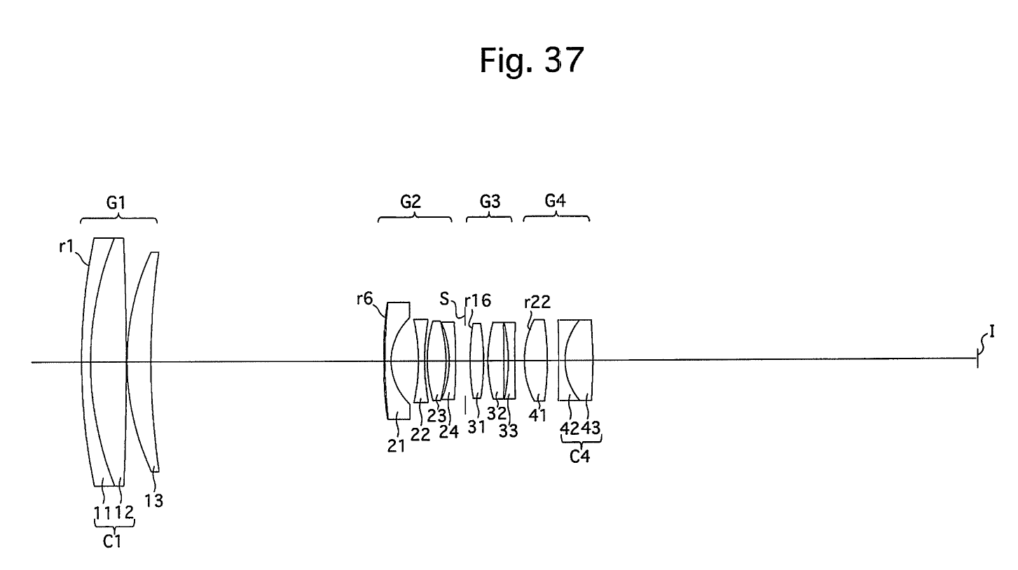

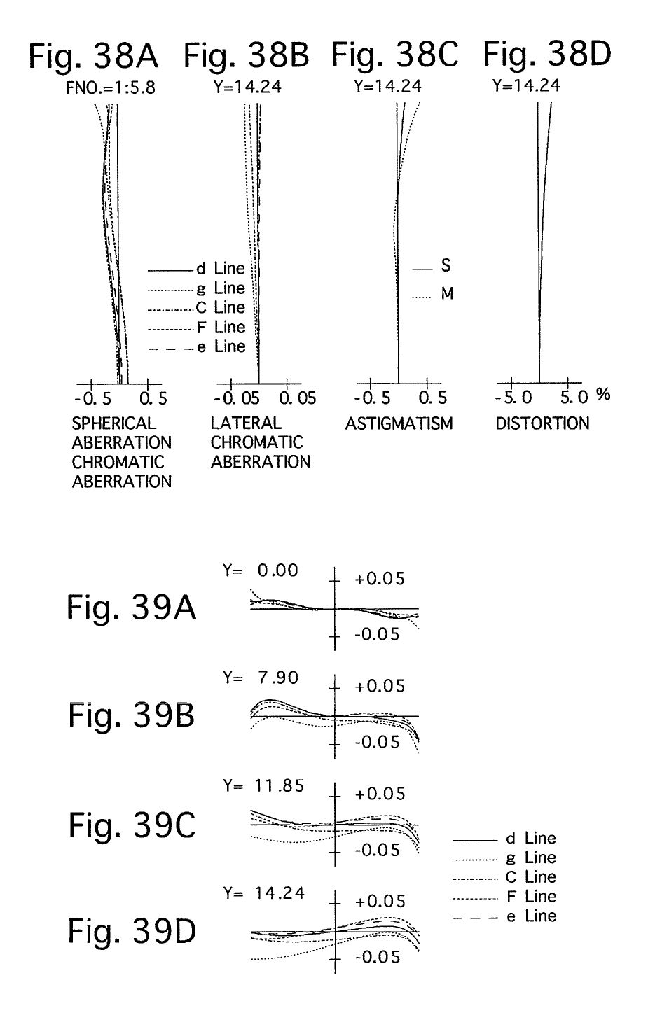

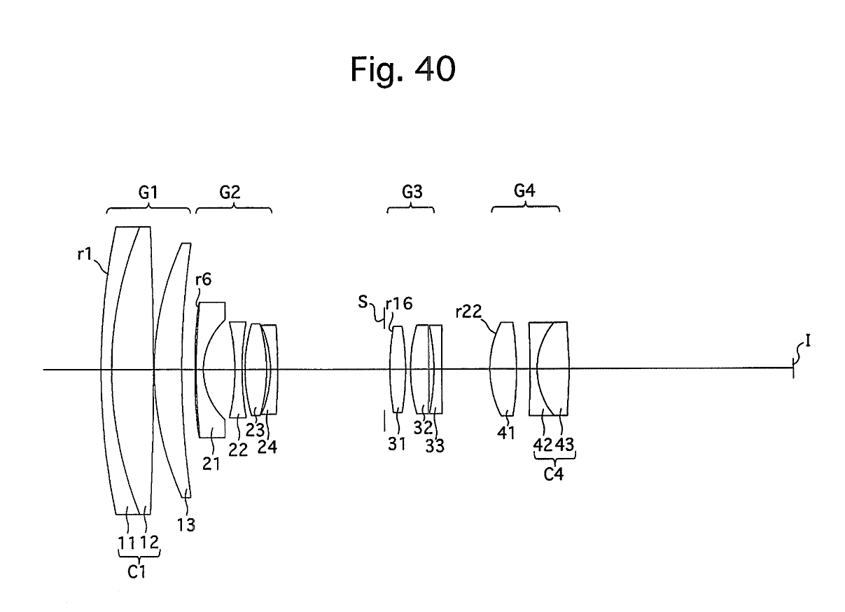

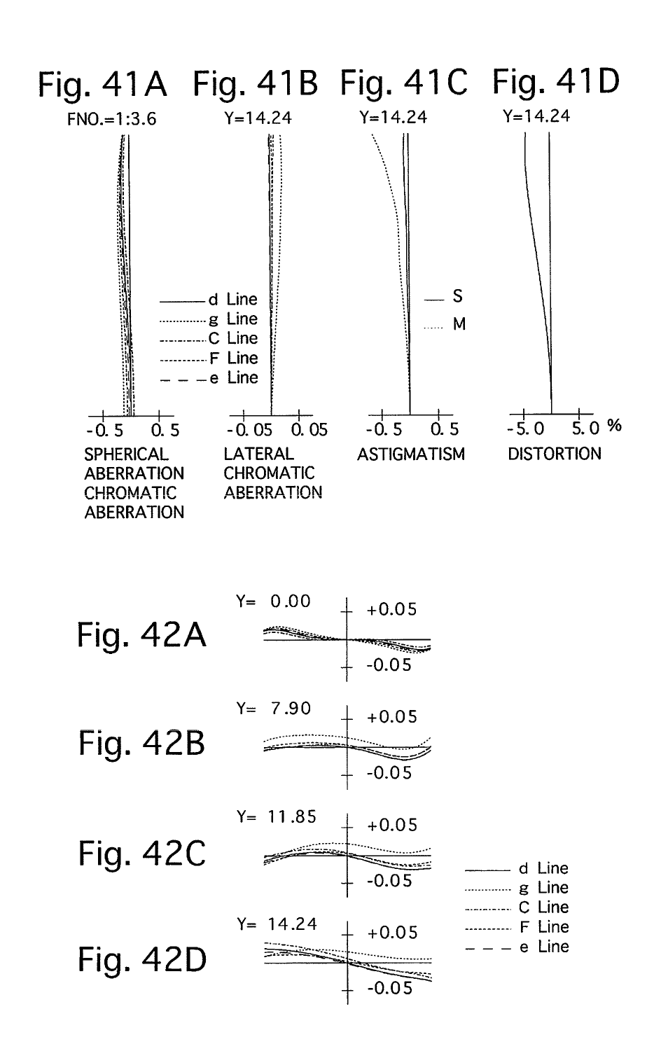

FIGS. 37 through 42D and Tables 25 through 28 show a seventh numerical embodiment of a high zoom-ratio zoom lens system according to the present invention. FIG. 37 shows a lens arrangement of the seventh numerical embodiment of the high zoom-ratio zoom lens system when an object at infinity is in an in-focus state at the long focal length extremity. FIGS. 38A, 38B, 38C and 38D show various aberrations that occurred in the lens arrangement shown in FIG. 37. FIGS. 39A, 39B, 39C and 39D show various lateral aberrations that occurred in the lens arrangement shown in FIG. 37. FIG. 40 shows a lens arrangement of the seventh numerical embodiment of the high zoom-ratio zoom lens system, according to the present invention when an object at infinity is in an in-focus state at the short focal length extremity. FIGS. 41A, 41B, 41C and 41D show various aberrations that occurred in the lens arrangement shown in FIG. 40. FIGS. 42A, 42B, 42C and 42D show various lateral aberrations that occurred in the lens arrangement shown in FIG. 40. Table 25 shows the lens surface data, Table 26 shows various zoom lens system data, Table 27 shows the aspherical surface data, and Table 28 shows the lens group data of the zoom lens system according to second numerical embodiment.

The fundamental lens arrangement of the seventh numerical embodiment is the same as that of the first numerical embodiment.

TABLE 25
SURFACE DATA

| Surf. No. | r | d | N(d) | νd |
|---|---|---|---|---|
| 1 | 124.415 | 1.800 | 1.84666 | 23.8 |
| 2 | 67.011 | 7.130 | 1.49700 | 81.6 |
| 3 | −588.686 | 0.150 | | |
| 4 | 53.028 | 4.745 | 1.72916 | 54.7 |
| 5 | 151.543 | d5 | | |
| 6 * | 191.082 | 0.200 | 1.52972 | 42.7 |
| 7 | 111.000 | 1.250 | 1.83481 | 42.7 |
| 8 | 12.162 | 5.397 | | |
| 9 | −36.765 | 1.220 | 1.88300 | 40.8 |
| 10 | 48.983 | 0.512 | | |
| 11 | 28.992 | 3.696 | 1.84666 | 23.8 |
| 12 | −28.992 | 0.672 | | |
| 13 | −19.655 | 1.250 | 1.77250 | 49.6 |
| 14 | −107.322 | d14 | | |
| 15 (Diaphragm) | ∞ | 0.930 | | |
| 16 | 46.248 | 2.681 | 1.48749 | 70.4 |
| 17 | −46.248 | 0.860 | | |
| 18 | 29.212 | 3.159 | 1.48749 | 70.4 |
| 19 | −500.406 | 0.884 | | |
| 20 | −36.698 | 1.300 | 1.60562 | 43.7 |
| 21 | 373.026 | d21 | | |
| 22 | 18.245 | 4.579 | 1.45860 | 90.2 |
| 23 | −53.681 | 2.314 | | |
| 24 | −187.806 | 1.200 | 1.79952 | 42.2 |
| 25 | 12.794 | 5.500 | 1.58944 | 60.8 |
| 26 * | −67.248 | — | | |

The asterisk (*) designates an aspherical surface which is rotationally symmetrical with respect to the optical axis.

TABLE 26
ZOOM LENS SYSTEM DATA
Zoom Ratio 7.06

| | Short-FLE | IFL | Long-FLE |
|---|---|---|---|
| FNO. | 3.58 | 5.33 | 5.77 |
| F | 18.60 | 70.11 | 131.29 |
| W | 38.66 | 11.16 | 6.04 |
| Y | 14.24 | 14.24 | 14.24 |
| FB | 38.498 | 65.218 | 76.257 |
| L | 118.93 | 159.329 | 177.853 |
| d5 | 2.281 | 34.187 | 46.320 |
| d14 | 18.381 | 6.143 | 1.945 |
| d21 | 8.338 | 2.351 | 1.900 |

TABLE 27
Aspherical Surface Data (the aspherical surface
coefficients not indicated are zero (0.00)):

| S. No. | K | A4 | A6 | A8 |
|---|---|---|---|---|
| 6 | 0.000 | 0.2470E−04 | −0.6878E−07 | 0.1528E−09 |
| | | A10 | | |
| | | 0.9162E−13 | | |
| S. No. | K | A4 | A6 | A8 |
| 26 | 0.000 | 0.3632E−04 | 0.1052E−06 | 0.5100E−09 |

TABLE 28
LENS GROUP DATA

| Lens Group | 1^{st} Surf. | Focal Length |
|---|---|---|
| 1 | 1 | 87.165 |
| 2 | 6 | −12.142 |
| 3 | 16 | 44.609 |
| 4 | 22 | 44.226 |

The numerical values of each condition for each numerical embodiment are shown in Table 29.

TABLE 29

| | Embod. 1 | Embod. 2 | Embod. 3 | Embod. 4 |
|---|---|---|---|---|
| Cond. (1) | 2.00 | 1.81 | 1.82 | 1.73 |
| Cond. (2) | 1.95 | 1.83 | 1.98 | 2.14 |
| Cond. (3) | 0.00139 | 0.00139 | 0.00126 | 0.00139 |
| Cond. (4) | 90.19 | 90.19 | 90.19 | 90.19 |

| | Embod. 5 | Embod. 6 | Embod. 7 |
|---|---|---|---|
| Cond. (1) | 1.72 | 1.80 | 1.97 |
| Cond. (2) | 2.25 | 1.87 | 1.94 |
| Cond. (3) | 0.00139 | 0.00127 | 0.00139 |
| Cond. (4) | 83.08 | 89.58 | 90.19 |

As can be understood from Table 29, the first through seventh embodiments satisfy conditions (1) through (4). Furthermore, as can be understood from the aberration diagrams, the various aberrations are suitably corrected.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A high-ratio zoom lens system comprises a positive first lens group, a negative second lens group, a positive third lens group, and a positive fourth lens group, in that order from an object,
wherein upon zooming from the short focal length extremity to the long focal length extremity, said first through fourth lens groups move along the optical axis thereof, while the distance between said first lens group and said second lens group increases, and the distance between said second lens group and said third lens group decreases;
wherein said first lens group comprises a negative lens element having a concave surface on the image side, a positive lens element having a convex surface on the object side, and a positive lens element having a convex surface on the object side, in that order from the object; and
wherein said high-ratio zoom lens system satisfies the following conditions:
1.7<f1/f4<2.02
1.82<(f1×f4)/(f3)²<2.3
wherein
f1 designates the focal length of said first lens group,
f3 designates the focal length of said third lens group, and
f4 designates the focal length of said fourth lens group.

2. The high-ratio zoom lens system according to claim 1, further satisfying the following condition:

|ΔP₁₁₋₁₂/Δνd₁₁₋₁₂|<0.0015
wherein
ΔP₁₁₋₁₂=(ΔP_{g-F}11−ΔP_{g-F}12), and
Δνd₁₁₋₁₂=νd11−νd12,
wherein
ΔP_{g-F}11 designates the partial dispersion ratio of said negative lens element in said first lens group,
ΔP_{g-F}12 designates the partial dispersion ratio of the object-side positive lens element in said first lens group;
νd11 designates the Abbe number with respect to the d-line of said negative lens element in said first lens group; and
νd12 designates the Abbe number with respect to the d-line of said object-side positive lens element in said first lens group.

3. The high-ratio zoom lens system according to claim 1, wherein said fourth lens group comprises a positive lens element, and a cemented lens formed from a negative lens element and a positive lens element, in that order from the object.

4. The high-ratio zoom lens system according to claim 3, further satisfying the following condition:
νd41>80
wherein
νd41 designates the Abbe number with respect to the d-line of said object-side positive lens element in said fourth lens group.

5. The high-ratio zoom lens system according to claim 1, wherein said third lens group comprises a positive lens element, a positive lens element, and a negative lens element having a concave surface on the object side, in that order from the object.
